(19) United States
(12) Patent Application Publication
(10) Pub. No.: US 2011/0096254 A1
(43) Pub. Date: Apr. 28, 2011

(54) Liquid Crystal Device

(75) Inventor: Hajime Ikeda, Kanagawa (JP)

(73) Assignee: Nano Loa, Inc., Kawasaki-shi, KANAGAWA (JP)

(21) Appl. No.: 12/526,125

(22) PCT Filed: Feb. 6, 2008
(86) PCT No.: PCT/JP2008/052384

§ 371 Date: Oct. 4, 2010

(30) Foreign Application Priority Data
Feb. 7, 2007 (JP) 2007-028182

(51) Int. Cl. G02F 1/133

(52) U.S. Cl. 349/33

(57) ABSTRACT

A liquid crystal device, comprising, at least, a pair of polarizing elements being disposed so that the transmission axes thereof are perpendicular to each other; a liquid crystal element disposed between the pair of polarizing elements; and voltage applying means for applying a voltage to the liquid crystal element. The liquid crystal element is such that it enables high-speed optical response, and the optical axis azimuth thereof is rotatable in response to the strength and/or direction of an electric field to be applied thereto. The voltage applying means is capable of controlling a voltage to be applied from the voltage applying means to the liquid crystal element, in response to the liquid crystal molecular alignment in the liquid crystal material. There is provided a liquid crystal device having a temperature-compensating function so as to achieve a good light-dark ratio.

### TECHNICAL FIELD

The present invention relates to a liquid crystal device having a reduced temperature dependency, which is suitably usable for various display devices and the like including an optical shutter device and a display.

### BACKGROUND ART

In recent years, combined with the progress in technology aiming at a so-called “ubiquitous society”, various needs for the display technique in general, such as high-speed response, downsizing and high display quality, are sophisticated. In order to meet these needs, also in the field of visual display and depiction, the display image processing technique such as three-dimensional display, selective invisibility and light control is rapidly advancing and becoming speeded-up and complicated. On the other hand, improvement of the environment related to information transfer including optical communication using an optical fiber cable or the like is promoted, and attempts are being made to realize large-volume high-speed data or information transfer.

In general, in various fields including the field of visual display and depiction, various mechanical/electrical devices have been heretofore used as the mechanical switch or shutter mechanism for turning ON/OFF the light. Out of these devices, a chopper comprising a motor and a rotating plate having formed therein a slit, and a mechanical shutter using a piezoelectric (or electrostrictive) element as the actuator have a simple structure and therefore, are being generally used.

However, a tendency of attaching importance particularly to the properties suitable for use in the so-called ubiquitous society has recently intensified and to cope with this trend, as for the switch/shutter mechanism, a device utilizing an electro-optical effect of, for example, a crystal or a liquid crystal and being excellent in terms of downsizing, electric power saving, noise reduction and the like has come into use.

Furthermore, the above-described device having a conventional mechanical mechanism is subject to wear in its rocking portion to some degree or another, and the reliability of the mechanical device inevitably tends to decrease. Above all, in an application where the device is used at such a high speed level as clicking the shutter several tens of times or more for 1 second, the rocking portion is worn to a significant extent. Of course, fairly severe vibration or noise is generated from the worn portion or the actuator portion such as motor or piezoelectric/electrostrictive element.

In addition to these problems, in view of downsizing, electric power saving and the like described above, the trend toward the use of a device utilizing the electro-optical effect of, for example, a crystal or a liquid crystal is particularly intensifying in recent years.

However, these electro-optical devices are not free of a problem. For example, in the case of a PLZT (lead lanthanum-added zirconate titanate) crystal having an electro-optical effect, a driving voltage of several hundreds of V is necessary for obtaining a sufficiently high transmittance and depending on the electrode structure of the optical shutter, breakdown may occur due to the high voltage. Also, by the nature as a crystal, this device has a strong tendency that growth in size is difficult, as compared with a liquid crystal enabling production of a large-screen display of even 100 inches.

Also, in the case of a device using a TN liquid crystal, the driving voltage for operation may be a low voltage of several V, but the response speed is as low as approximately several tens of ms and although the “rising up” may be improved by applying a high voltage, the “rising down” is not improved, making the high-speed operation to still remain difficult. In the light of high-speed response and low voltage, use of a ferroelectric liquid crystal may be considered, but the ferroelectric liquid crystal has spontaneous polarization and its driving disadvantageously requires a large amount of current compared with TN liquid crystal and the like. In addition, the site of extinction position in a ferroelectric liquid crystal varies depending on the temperature, and a mechanism to compensate for this change of extinction position becomes necessary.

As the method for such temperature compensation, various devices in accordance with the stable position “slipped” from the original position due to the ambient temperature are required, and the construction of the liquid crystal device or optical shutter inevitably becomes complicated. Known examples of the device or method used for adjustment to the stable position include a mechanical method of adjusting the position of a polarizing device or surface-stabilized ferroelectric liquid crystal display device (see, JP-A (Japanese Unexamined Patent Publication) No. 62-204229), a method of inserting a surface-stabilized ferroelectric liquid crystal device and a liquid crystal device having the same temperature dependency between polarizing devices, thereby canceling the temperature dependency (see, JP-A No. 4-186230), and a method of, instead of the above-described liquid crystal device having the same temperature dependency, inserting a compensation device that performs positioning or the like of the optical axis azimuth of a ½ wavelength plate in accordance with the temperature dependency of the surface-stabilized ferroelectric liquid crystal device (see, JP-A No. 4-186224).

[Patent Document 1] JP-A No. 62-204229

[Patent Document 2] JP-A No. 4-186230 [Patent Document 3] JP-A No. 4-186224

### DISCLOSURE OF THE INVENTION

An object of the present invention is to provide a liquid crystal device (for example, having an optical shutter function) capable of solving the problem encountered in the prior art.

Another object of the present invention is to provide a liquid crystal device having a temperature compensation function capable of achieving a good light/dark ratio condition.

A further object of the present invention is to provide a liquid crystal device having a good temperature compensation function substantially over the entire operation temperature range.

As a result of intensive studies, the present inventors have found that it is very effective for achieving the above-described object to use a liquid crystal element capable of rotating the optical axis azimuth in response to the strength and/or direction of an electric field to be applied thereto (for example, a polarization shielding-type smectic liquid crystal (hereinafter referred to as “PSS-LCD”)) and constitute a liquid crystal device by combining the liquid crystal element with a polarizing element and voltage applying means.

The liquid crystal device according to the present invention is based on the above-mentioned discovery. More specifically, such a liquid crystal device comprises, at least:

a pair of polarizing elements being disposed so that the transmission axes thereof are perpendicular to each other,

a liquid crystal element disposed between the pair of polarizing elements, and

voltage applying means for applying a voltage to the liquid crystal element,

wherein the liquid crystal element comprises, at least, a pair of substrates and a liquid crystal material disposed between the pair of substrates; the optical axis azimuth of the liquid crystal element being rotatable in response to the strength and/or direction of an electric field to be applied thereto; and

the voltage applying means is capable of controlling a voltage to be applied from the voltage applying means to the liquid crystal element, in response to the liquid crystal molecular alignment in the liquid crystal material.

The present invention also provides a liquid crystal device comprising, at least:

a pair of polarizing elements being disposed so that the transmission axes thereof are crossed with each other,

a liquid crystal element disposed between the pair of polarizing elements, and

angle adjusting means for adjusting the angle between the liquid crystal element and the polarizing element,

wherein the liquid crystal element comprises, at least, a pair of substrates and a liquid crystal material disposed between the pair of substrates, the optical axis azimuth of the liquid crystal element being rotatable in response to the strength and/or direction of an electric field to be applied thereto; and

the angle adjusting means is capable of controlling the angle between the liquid crystal element and the polarizing element in response to the liquid crystal molecular alignment in the liquid crystal material.

The present invention further provides a liquid crystal device comprising, at least:

a pair of polarizing elements being disposed so that the transmission axes thereof are perpendicular to each other,

a liquid crystal element disposed between the pair of polarizing elements, and

voltage applying means for applying a voltage to the liquid crystal element,

wherein the liquid crystal element comprises, at least, a pair of substrates and a liquid crystal material disposed between the pair of substrates; the initial molecular alignment in the liquid crystal element having a direction which is parallel or almost parallel to the alignment treatment direction for the liquid crystal material; the liquid crystal material showing almost no spontaneous polarization which is perpendicular to the pair of substrates in the absence of a voltage to be externally applied thereto; and

the voltage applying means is capable of controlling a voltage to be applied from the voltage applying means to the liquid crystal element, in response to the liquid crystal molecular alignment in the liquid crystal material.

The present invention further provides a liquid crystal device, comprising at least:

a pair of polarizing elements being disposed so that the transmission axes thereof are perpendicular to each other,

a liquid crystal element disposed between the pair of polarizing elements, and

angle adjusting means for adjusting the angle between the liquid crystal element and the polarizing element,

wherein the liquid crystal element comprises at least a pair of substrates and a liquid crystal material disposed between the pair of substrates; the initial molecular alignment in the liquid crystal element having a direction which is parallel or almost parallel to the alignment treatment direction for the liquid crystal material; the liquid crystal material showing almost no spontaneous polarization which is perpendicular to the pair of substrates in the absence of a voltage to be externally applied thereto; and

the angle adjusting means is capable of controlling the angle between the liquid crystal element and the polarizing element in response to the liquid crystal molecular alignment in the liquid crystal material.

In the liquid crystal device according to the present invention having the above-mentioned constitution, a liquid crystal element capable of rotating the optical axis azimuth in response to the strength and/or direction of an electric field to be applied thereto can be used without any particular limitation, but a “PSS-LCD” (polarization shielding-type smectic liquid crystal) may preferably be used. In this PSS-LCD, the liquid crystal molecules generally tend to align in the buffing direction. In the present invention, the quantity of light transmitted through the liquid crystal can be controlled, for example, by the electric field intensity.

Generally, in the case of an analog gradation LCD where liquid crystal molecules switch their direction in the same plane parallel to the buffing direction, the transmitted light quantity has temperature dependency. In the present invention, such temperature dependency can be reduced. In the above-described PSS-LCD device (PSS-LCD), liquid crystal molecules move quickly and therefore, such temperature dependency tends to be relatively strong.

In the normal ferroelectric LC that has been conventionally used, alignment of liquid crystal molecules changes only between “two values” (by a voltage exceeding a certain threshold value), whereas in the PSS-LCD, the “tilt angle” of the liquid crystal molecular alignment can be changed in an analog manner. For this reason, in the present invention, PSS-LCD is suitably usable in particular.

In the case of using a liquid crystal element, since the indoor temperature (for example, in a TV station) changes from the outdoor temperature, a so-called “black floating” phenomenon sometimes occurs in the liquid crystal element due to the temperature change. Such a change of black (that corresponds, in the change of the transmitted light quantity, to the “denominator” of a fraction) is known to become visually prominent. Colors other than black (colors corresponding to the “numerator” but not to the “denominator” of a fraction) are known to less affect the image even when the transmitted light quantity is somewhat changed.

The present invention includes, for example, the following embodiments.

[1] A liquid crystal device, comprising at least:

a pair of polarizing elements being disposed so that the transmission axes thereof are perpendicular to each other,

a liquid crystal element disposed between the pair of polarizing elements, and

voltage applying means for applying a voltage to the liquid crystal element,

wherein the liquid crystal element comprises, at least, a pair of substrates and a liquid crystal material disposed between the pair of substrates; the optical axis azimuth of the liquid crystal element being rotatable in response to the strength and/or direction of an electric field to be applied thereto; and

the voltage applying means is capable of controlling a voltage to be applied from the voltage applying means to the liquid crystal element, in response to the liquid crystal molecular alignment in the liquid crystal material.

[2] A liquid crystal device comprising, at least:

a pair of polarizing elements being disposed so that the transmission axes thereof are crossed with each other,

a liquid crystal element disposed between the pair of polarizing elements, and

angle adjusting means for adjusting the angle between the liquid crystal element and the polarizing element,

wherein the liquid crystal element comprises, at least, a pair of substrates and a liquid crystal material disposed between the pair of substrates, the optical axis azimuth of the liquid crystal element being rotatable in response to the strength and/or direction of an electric field to be applied thereto; and

the angle adjusting means is capable of controlling the angle between the liquid crystal element and the polarizing element in response to the liquid crystal molecular alignment in the liquid crystal material.

[3] A liquid crystal device comprising, at least:

a pair of polarizing elements being disposed so that the transmission axes thereof are perpendicular to each other,

a liquid crystal element disposed between the pair of polarizing elements, and

voltage applying means for applying a voltage to the liquid crystal element,

wherein the liquid crystal element comprises, at least, a pair of substrates and a liquid crystal material disposed between the pair of substrates; the initial molecular alignment in the liquid crystal element having a direction which is parallel or almost parallel to the alignment treatment direction for the liquid crystal material; the liquid crystal material showing almost no spontaneous polarization which is perpendicular to the pair of substrates in the absence of a voltage to be externally applied thereto; and

the voltage applying means is capable of controlling a voltage to be applied from the voltage applying means to the liquid crystal element, in response to the liquid crystal molecular alignment in the liquid crystal material.

[4] A liquid crystal device, comprising at least:

a pair of polarizing elements being disposed so that the transmission axes thereof are perpendicular to each other,

a liquid crystal element disposed between the pair of polarizing elements, and

angle adjusting means for adjusting the angle between the liquid crystal element and the polarizing element,

wherein the liquid crystal element comprises at least a pair of substrates and a liquid crystal material disposed between the pair of substrates; the initial molecular alignment in the liquid crystal element having a direction which is parallel or almost parallel to the alignment treatment direction for the liquid crystal material; the liquid crystal material showing almost no spontaneous polarization which is perpendicular to the pair of substrates in the absence of a voltage to be externally applied thereto; and

the angle adjusting means is capable of controlling the angle between the liquid crystal element and the polarizing element in response to the liquid crystal molecular alignment in the liquid crystal material.

[5] A liquid crystal device according to [1] or [2], wherein the liquid crystal element is capable of rotating the optical axis azimuth in response to the strength and/or direction of an electric field to be applied thereto at a level of 10 to 2 V/μm.

[6] A liquid crystal device according to [1], [2] or [5], wherein the liquid crystal element is capable of high-speed response at a level of 1 ms or less.

[7] A liquid crystal device according to any one of [1] to [6], which has an optical shutter function.

[8] A liquid crystal device according to any one of [1] to [7], wherein the liquid crystal molecular alignment in the liquid crystal element can be represented by the temperature of the liquid crystal material.

[9] A liquid crystal device according to any one of claims [1] to [8], wherein the liquid crystal molecular alignment in the liquid crystal material can be represented by the intensity of output light from one of the polarizing elements.

[10] A liquid crystal device, comprising at least:

a pair of polarizing elements being disposed so that the transmission axes thereof are perpendicular to each other,

a liquid crystal element disposed between the pair of polarizing elements, and

light generation means for providing light to the liquid crystal element,

wherein the liquid crystal element comprises, at least, a pair of substrates and a liquid crystal material disposed between the pair of substrates; the minimum strength of light having passed through the liquid crystal element being measurable in terms of the angle of optical axis azimuth.

[11] A liquid crystal device, comprising at least:

a pair of polarizing elements being disposed so that the transmission axes thereof are perpendicular to each other,

a liquid crystal element disposed between the pair of polarizing elements,

rotation means for providing a desired rotation angle to the liquid crystal element,

light generation means for providing light to the liquid crystal element, and

light detection means for detecting light having passed through the liquid crystal element,

wherein the liquid crystal element comprises, at least, a pair of substrates and a liquid crystal material disposed between the pair of substrates; the rotation means being rotatable so that the strength of light having passed through the liquid crystal element becomes minimum, and the angle of the rotation means can be measured in terms of the angle of optical axis azimuth.

### BRIEF DESCRIPTION OF THE DRAWINGS

FIG. 1 is a schematic plan view showing the optical axis azimuth and temperature dependency in the state of an electric field being not applied in a surface-stabilized ferroelectric liquid crystal.

FIG. 2 is a graph showing one example of the temperature dependency of the tilt angle in a surface-stabilized ferroelectric liquid crystal.

FIG. 3 is a graph showing one example of the temperature dependency of the rotation angle θ in PSS-LCD.

FIG. 4 is a schematic plan view showing the optical axis azimuth in the state of an electric field being not applied in PSS-LCD.

FIG. 5 is a schematic plan view and a schematic cross-sectional view, showing the electric field applying direction and the rotation angle and rotation direction of the optical axis azimuth in PSS-LCD.

FIG. 6 is a schematic plan view showing the temperature dependency in PSS-LCD.

FIG. 7 is a schematic cross-sectional view showing the light-shielding state and light-transmitting state of the optical shutter in PSS-LCD.

FIG. 8 is a schematic cross-sectional view showing the temperature dependency of the optical shutter in PSS-LCD.

FIG. 9 is a graph showing one example of reduction of the contrast ratio due to temperature dependency of the optical shutter in PSS-LCD.

FIG. 10 is a schematic plan view showing one example of the method for improving the temperature dependency by the voltage control in a PSS-LCD optical shutter.

FIG. 11 is a schematic cross-sectional view showing one example of the optical shutter by PSS-LCD. FIG. 12 is a schematic cross-sectional view showing another example of the optical shutter by PSS-LCD.

FIG. 13 is a schematic plan view showing one example of the principle of improving the temperature dependency by the element rotation control in a PSS-LCD optical shutter.

FIG. 14 is a schematic cross-sectional view showing one example of the optical shutter by PSS-LCD (an example where mechanical driving is utilized).

FIG. 15 is a schematic cross-sectional view showing another example of the optical shutter by PSS-LCD (an example where mechanical driving is utilized).

FIG. 16 is a schematic perspective view showing one example of the construction for mechanically improving the temperature dependency of an optical shutter by PSS-LCD.

FIG. 17 is a schematic perspective view showing another example of the construction for mechanically improving the temperature dependency of an optical shutter by PSS-LCD. FIG. 18 shows the results of a working example where the temperature dependency is improved by the control of the applied voltage to an optical shutter by PSS-LCD.

FIG. 19 is a graph showing one example of the improvement of temperature dependency by the control of the applied voltage to an optical shutter by PSS-LCD.

FIG. 24 is a schematic perspective view showing one example of the construction (measurement system) of components suitable for the exact measurement of optical axis azimuth, which is usable in the present invention.

FIG. 25 is a schematic perspective view showing one example of the PSS-LCD cell produced in a working example of the present invention.

FIG. 26 is a graph showing one example of the control voltage curve obtained in Example of the present invention.

FIG. 27 is a graph showing one example of the control rotation angle curve obtained in a working example of the present invention.

### BEST MODE FOR CARRYING OUT THE INVENTION

The present invention is described in detail below by referring to the drawings, if desired. In the following description, unless otherwise indicated, the “parts” and “%” indicating a quantitative ratio are on the mass basis.

### Embodiment 1 of Liquid Crystal Device

In one embodiment of the present invention, the liquid crystal device comprises at least a pair of polarizing elements with respective transmission axes being perpendicular to each other, a liquid crystal element disposed between the pair of polarizing elements, and voltage applying means for applying a voltage to the liquid crystal element. The liquid crystal element is a liquid crystal element which comprises at least a pair of substrates and a liquid crystal material disposed between the pair of substrates and at the same time, in which the liquid crystal material can rotate the optical axis azimuth in response to the strength and/or direction of an electric field to be applied thereto. Furthermore, the voltage applying means is voltage applying means capable of controlling a voltage to be applied from the voltage applying means to the liquid crystal element in accordance with the liquid crystal molecular alignment in the liquid crystal material.

### Embodiment 2 of Liquid Crystal Device

In another embodiment of the present invention, the liquid crystal device is a liquid crystal device comprising at least a pair of polarizing elements being disposed so that the transmission axes thereof are perpendicular to each other, a liquid crystal element disposed between the pair of polarizing elements, and angle adjusting means for adjusting the angle between the liquid crystal element and the polarizing element. The liquid crystal element is a liquid crystal element which comprises at least a pair of substrates and a liquid crystal material disposed between the pair of substrates and at the same time, in which the liquid crystal material can rotate the optical axis azimuth in response to the strength and/or direction of an electric field to be applied thereto. Furthermore, the angle adjusting means is angle adjusting means capable of controlling the angle between the liquid crystal element and the polarizing element in accordance with the liquid crystal molecular alignment in the liquid crystal material.

### (Principle of the Present Invention)

The principle of the present invention is described below by making a comparison with the conventional temperature compensation method, if desired (one example of the liquid crystal device).

For example, the following case is described as a practical example of the liquid crystal device. As for the stereoscopic image display technique, a display method sometimes called a slit-type integral photography system is known. In this display method, three-dimensional images seen from different viewpoints and disposed like a strip are sequentially displayed, as a result, three-dimensional images at a plurality of different viewpoints produce afterimages within the afterimage time of the human eye and are perceived as a stereoscopic image.

In this integral photography technique, for sequentially displaying three-dimensional images disposed like a strip, a strip-shaped high-speed optical shutter is used. The pitch of strips is very narrow and at the same degree as the pixel pitch of normal FPD (flat panel display), and a device following a very high-speed shuttering time is required to sequentially display a plurality of images in about 1/30 seconds that is the afterimage time of the human eye.

For example, when 8 image strips in different fields of view are sequentially displayed in 1/30 seconds, the transmission time becomes about 4.2 milli-seconds per one strip. In the usage where a high-speed shutter operation is performed in such a micro-region, it is optimal to apply a liquid crystal display technique of performing the image display by light control similarly in a micro-region. However, for realizing the above-described transmission time of about 4.2 milli-seconds, a response speed with the rise-up time and the rise-down time each being 1 milli-second or less is necessary, and this is difficult to realize in the conventional optical shutters using a general TN liquid crystal.

It is supposed that in the case of using a polymer dispersion liquid crystal recently developed, a high-speed response of several milli-seconds can be obtained, but the liquid crystal viscosity needs to be reduced by applying a voltage of about 100 V and raising the ambient temperature to about 100° C. Also, since light is scattered and thereby shielded, the contrast ratio when viewed directly is disadvantageously low.

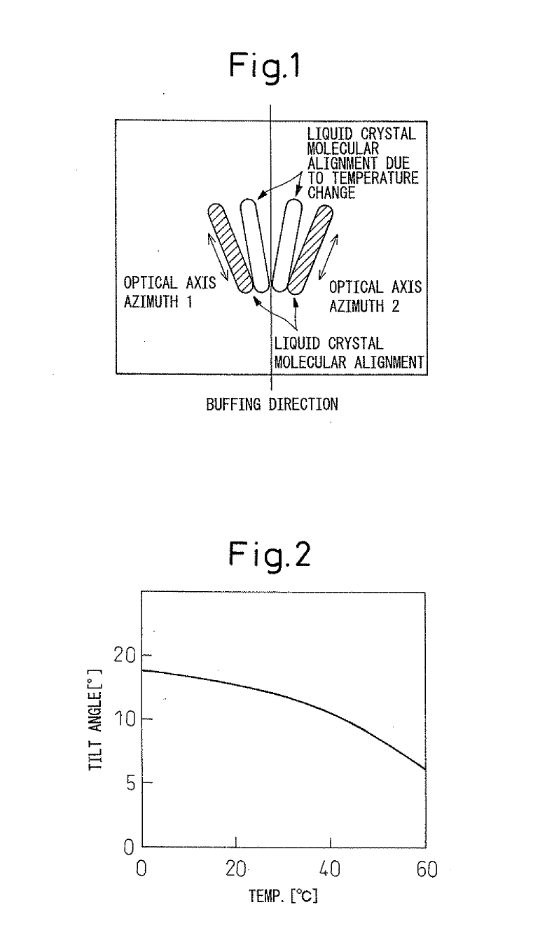

The problem in terms of the response speed is supposed to be solvable by the use of a surface-stabilized ferroelectric liquid crystal exhibiting high-speed response with the rise-up time and rise-down time each being several hundreds of micro-seconds. However, as shown in the schematic plan view of FIG. 1 and in the graph of FIG. 2, in an optical shutter, the bi-stable position and angle (tilt angle) for transmission and light shielding generally vary depending on the element temperature and therefore, a mechanism to compensate for such an effect of temperature is required (in the case of using PSS-LCD).

The technique of a polarization shielding-type smectic liquid crystal display (PSS-LCD) previously proposed by the present applicant (for details of this PSS-LCD, for example, Kohyo (National Publication of Translated Version) No. 2006-515935 may be referred to) is a technique enabling, for example, an electro-optical response in 400 micro-seconds as well as continuous gradation display at a low voltage.

Also, by virtue of good uniformity of alignment as compared with general ferroelectric liquid crystals, the contrast is locally high and in the case of PSS-LCD, even when fabricated as a large-screen display, the variation of the optical axis direction in the plane is reduced.

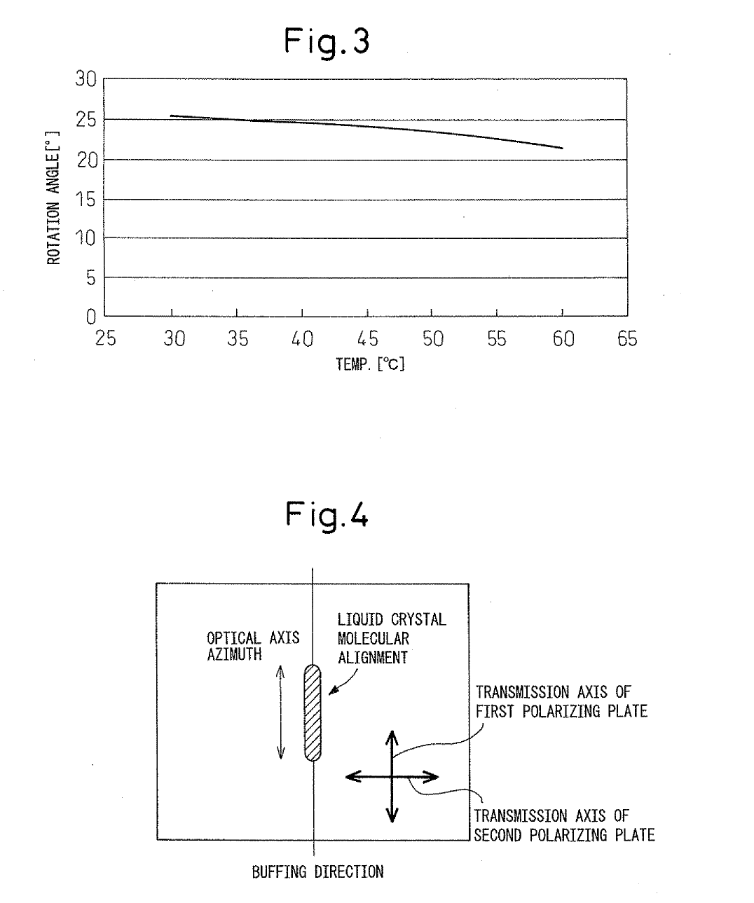

However, the temperature dependency like a surface-stabilized ferroelectric liquid crystal display using the same smectic liquid crystal is observed also in this PSS-LCD. The graph of FIG. 3 shows one example of the temperature dependency of the rotation angle θ when a rectangular wave of ±5 V is applied to a PSS-LCD element. As shown from FIG. 3, it may be understood that compared with the temperature dependency of the tilt angle of the above-described surface-stabilized ferroelectric liquid crystal, the temperature dependency of the rotation angle θ in PSS-LCD is gentle but the rotation angle is changed by the temperature change.

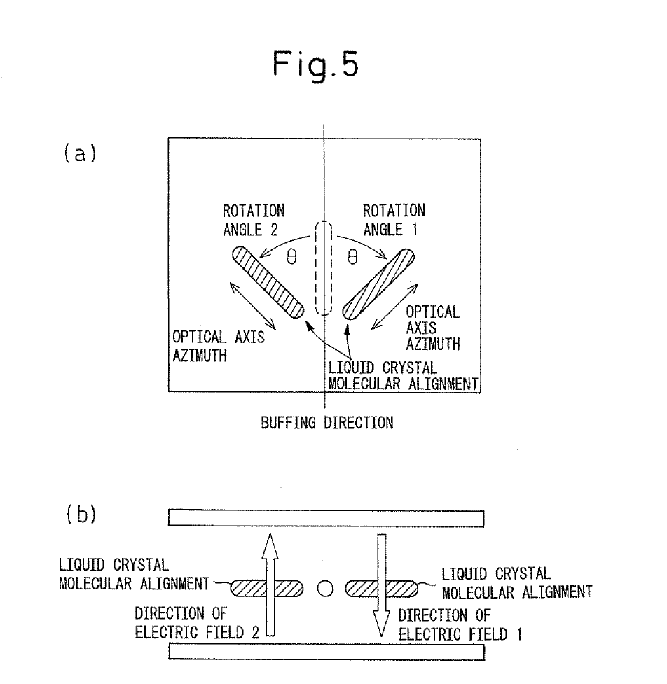

In the conventional gradation display PSS-LCD, a PSS-LCD element is disposed between two polarizing plates (under cross-Nicol arrangement) with respective transmission axes being perpendicular to each other and as shown in FIG. 4, the element is disposed such that the optical axis azimuth at the time of not applying an electric field becomes parallel to the transmission axis of either one polarizing plate. When light is made to be incident on such a system, light turned into linear polarization by the first polarizing plate is not subject to birefringent action of the liquid crystal layer and shielded by the second polarizing plate to minimize the transmitted light. As shown in FIG. 5, when an electric field is applied, the rotation angle becomes a rotation angle 1 or a rotation angle 2 according to the electric field direction and allows light to be transmitted by the birefringent action.

The rotation angle θ is determined by the electric field intensity, and the transmittance can be controlled by analog gradation. The transmitted light quantity here is expressed by the following formula (1) and when the rotation angle θ is ±45° and Δnd is λ/2, the transmitted light quantity becomes maximum. Formula (1):

$$I = {I}_{0} \cdot {sin}^{2} ( 2 θ ) \cdot {sin}^{2} ( \frac{πΔ nd}{λ} )$$

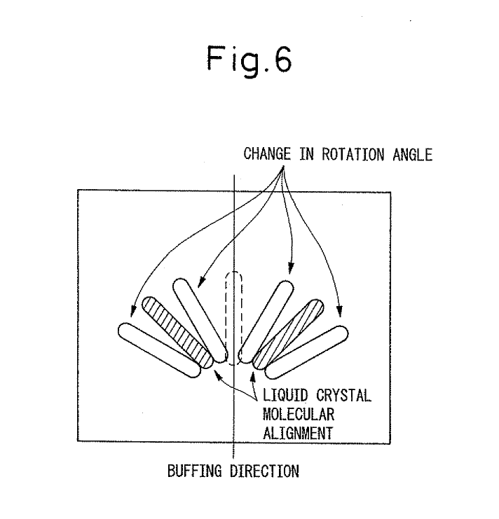

However, this rotation angle has temperature dependency as described above and even with the same electric field intensity, as shown in FIG. 6, the right/left rotation angle tends to be small at a high temperature and be large at a low temperature (that is, as indicated by “Change of Rotation Angle” in FIG. 6, when the element temperature is varied, even if an electric field to be applied thereto intensity is the same, the rotation angle changes). Therefore, even with the same electric field intensity, the transmittance may be changed according to the element temperature, and the light/dark ratio (contrast ratio) may decrease at high temperatures.

### (Operation Example of Optical Shutter)

The operation in one preferred embodiment of the optical shutter of the present invention is described below.

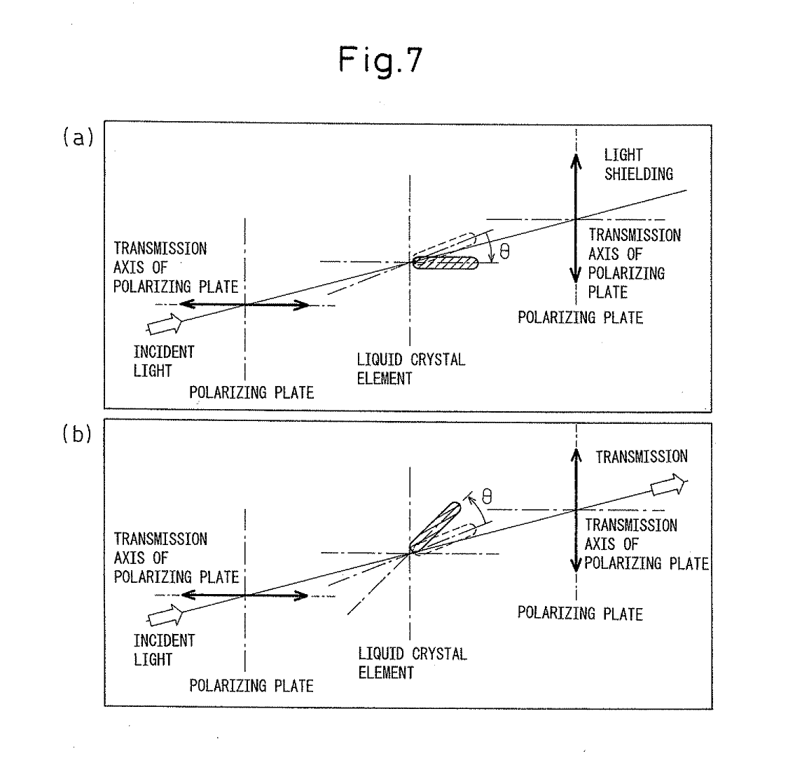

For example, as shown in FIG. 7(a), a PSS-LCD element is disposed between two polarizing plates with respective transmission axes being perpendicular and when out of two directions of electric field to be applied, an electric field in one direction is applied to make the optical axis azimuth rotated by a rotation angle θ according to the electric field intensity to be parallel to the transmission axis of one polarizing plate, the light is shielded to minimize the transmitted light. This state is referred to as the “light-shielding state” of the optical shutter.

Thereafter, as shown in FIG. 7(b), an electric field in the opposite direction from the “light-shielding state” is applied to rotate the optical axis azimuth by a rotation angle θ according to the electric field intensity, as a result, light is transmitted. This state is referred to as the “light-transmitting state”.

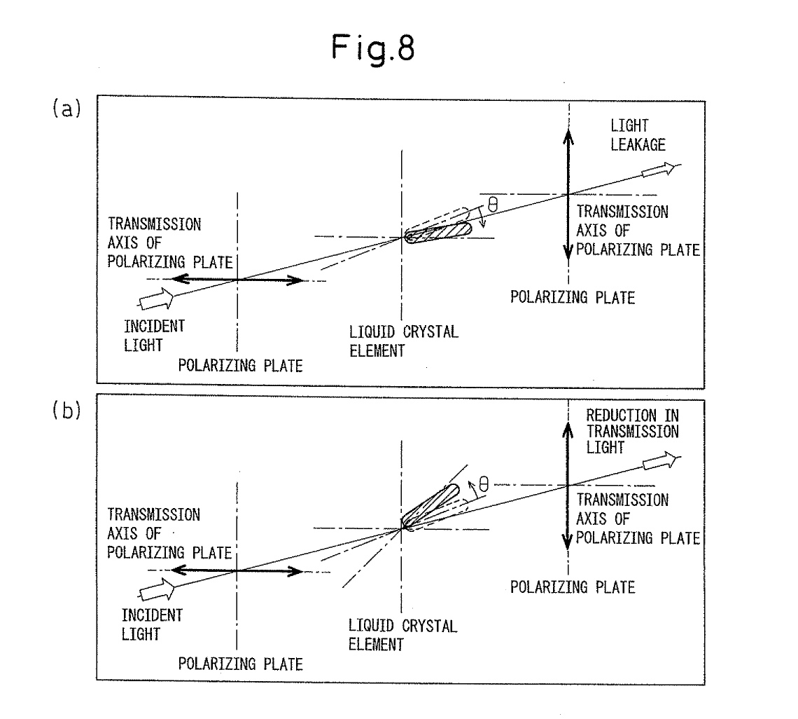

The liquid crystal alignment at these light-transmitting state and light-shielding state is very excellent as compared with the liquid crystal alignment in the state of an electric field being not applied and the transmitted light quantity is more increased in the light-transmitting state, while raising the light-blocking ratio in the light-shielding state. However, as shown in FIG. 8, when the element temperature is changed in the arrangement state above, even if an electric field to be applied thereto is the same, the rotation angle of the optical axis azimuth of the PSS-LCD element is changed and it is likely that light is leaked in the light-shielding state of FIG. 8(a) and the transmitted light quantity decreases in the light-transmitting state of FIG. 8(b).

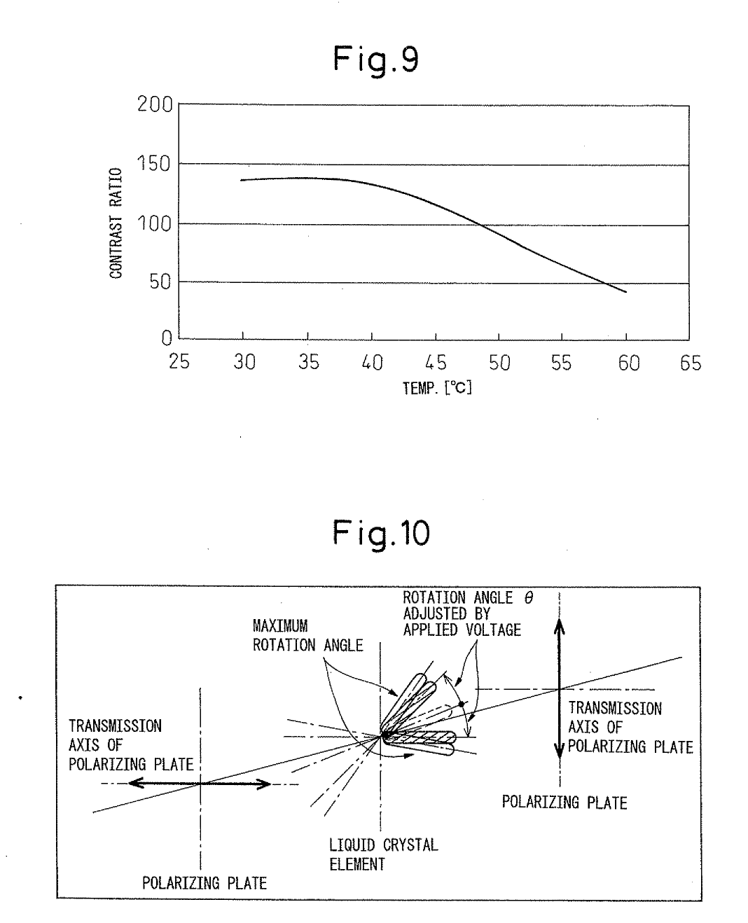

The graph of FIG. 9 showing the temperature dependency when adjusting the light-shielding state at 30° C. reveals that the contrast ratio decreases as the temperature rises. In order to solve such reduction of the contrast ratio, as shown in the schematic cross-sectional view of FIG. 10, the element temperature is set to, in the operation temperature range, a temperature giving a smallest rotation angle θ of the optical axis azimuth, and the optical axis azimuth rotated by the application of an electric field in one direction out of two electric field directions is allowed to become parallel to the transmission axis of one polarizing plate (in FIG. 10, the indication “maximum rotation angle” means “a maximum rotation angle at which the optical axis azimuth can be originally rotated”).

By setting the system as shown in FIG. 10, even when the temperature is changed and the rotation angle θ of the optical axis azimuth becomes large, the rotation angle θ can be made small by weakening the intensity of the electric field applied, whereby the transmission axis of the polarizing plate can be agreed with the optical axis azimuth and the rotation angle in the light-shielding state and the light-transmitting state can be made constant.

In the case where the total of right/left rotation angles for the smallest rotation angle θ in the operation temperature range is 45° or more, by performing the above-described control, the total of the right/left rotation angles of the optical axis azimuth can be adjusted to 45° in the entire operation temperature range and the transmitted light quantity in the light-transmitting state can be kept maximum.

### (Construction for Adjustment of Rotation Angle θ)

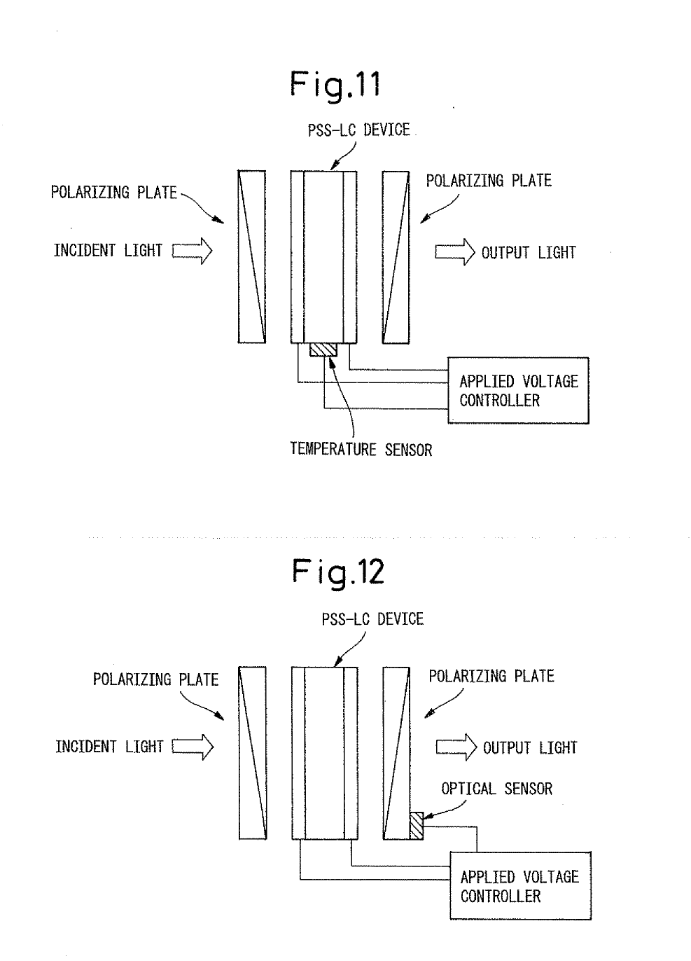

As regards the construction for the adjustment of the rotation angle θ, constructions of apparatuses of FIGS. 11 and 12 and the details of the entire operation are described below.

First, the construction in the schematic side view of FIG. 11 is described as one example.

Referring to FIG. 11, PSS-LCD is disposed between perpendicularly arranged polarizing plates. To this PSS-LCD, a temperature sensor element such as thermistor or platinum resistance element is equipped to sequentially acquire the temperature information of PSS-LCD. The acquired temperature information is compared with the information of electric field applied to PSS-LCD with respect to the measured temperature, which is recorded in the control part.

An electric field to be applied thereto information recorded in the control part is the information prepared by previously measuring the electric field giving a minimum transmitted light quantity in the light-shielding state of the PSS-LCD element and a maximum transmitted light quantity in the light-transmitting state with respect to the measured temperature. Accordingly, by controlling the system to apply an electric field with matched intensity to PSS-LCD, a condition providing a minimum transmitted light quantity in the light-shielding state and a maximum transmitted light quantity in the light-transmitting state can be always reproduced.

As another example, the construction in the schematic side view of FIG. 12 is described. A PSS-LCD element is disposed between perpendicularly arranged polarizing plates. On the light outgoing side, an optical sensor element such as photodiode or phototransistor is fixed to allow the transmitted light to be incident thereinto and sequentially acquires the transmitted light quantity information. There is performed a feedback control of judging whether the acquired transmitted light quantity is a minimum transmitted light quantity at the time of light-shielding state or a maximum transmitted light quantity at the time of light-transmitting state, and if the case is not so, changing the intensity of electric field applied to the PSS-LCD element, thereby acquiring the transmitted light quantity. By employing such a construction, the light-shielding state and the light-transmitting state can be constantly kept in the optimal state.

In practice, when the angle of the optical axis direction and the angle of the transmission axis of the polarizing plate come close, the transmitted light quantity difference tends to become small, increasing the difficulty in sensing a small light quantity difference in a large range as in the case of detecting the light-transmitting state. Therefore, in view of adjustment precision, it is rather preferred to adjust the application of an electric field so as to give a minimum transmitted light quantity in the light-shielding state. The same applies to the measurement of a control voltage to be applied, which is memorized by a method using also a temperature sensor. As for the optical sensor and temperature sensor, in view of temporal variation and frequency of the element temperature change, those having a cost-effective response speed may be selected.

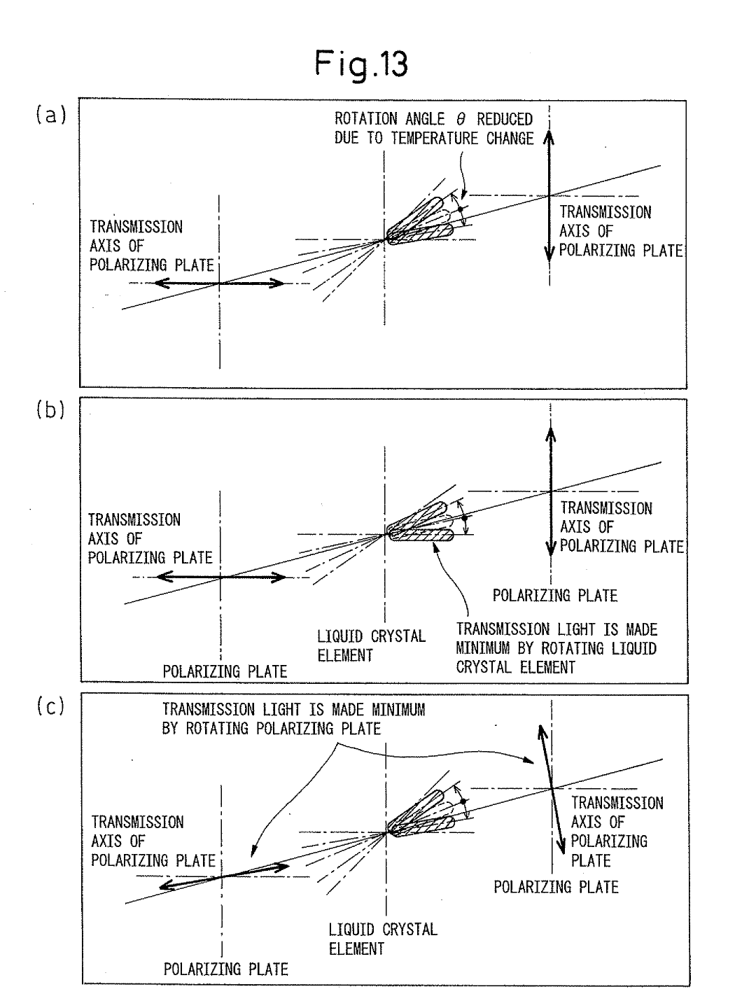

In the case where the change of maximum transmitted light quantity in the light-transmitting state need not be taken into consideration, the transmitted light quantity in the light-shielding state may be minimized also by mechanically adjusting the rotation angle θ. In the case of disposing a PSS-LCD element between two perpendicularly arranged polarizing plates, a mechanical mechanism shown in FIG. 13(b) of rotating the PSS-LCD element such that the optical axis azimuth rotated by the application of an electric field in one direction out of two directions of electric field to be applied becomes parallel to the transmission axis of one polarizing plate, or a mechanical mechanism shown in FIG. 13(c) of rotating two polarizing plates while keeping the perpendicular relationship may be employed to thereby minimize the transmitted light quantity in the light-shielding state (incidentally, in FIG. 13(a), the indication “rotation angle θ reduced due to temperature change” means a “rotation angle θ that has become small due to temperature change”).

### (Rotation Mechanism)

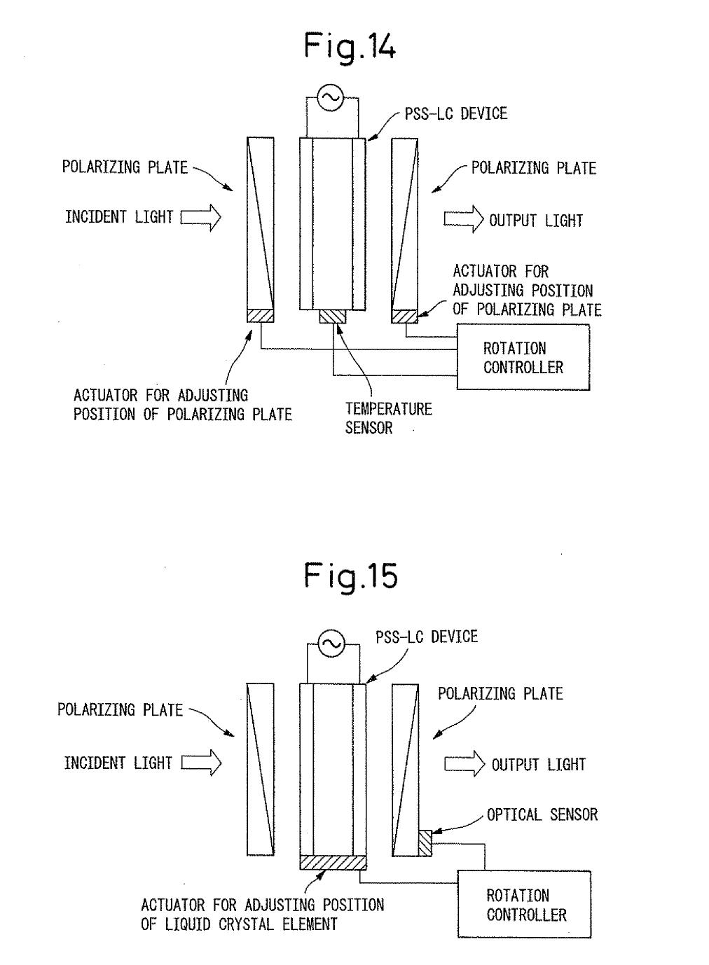

As regards the construction of the rotation mechanism, the construction of the apparatuses of FIGS. 14 to 16 and the details of the entire operation are described below.

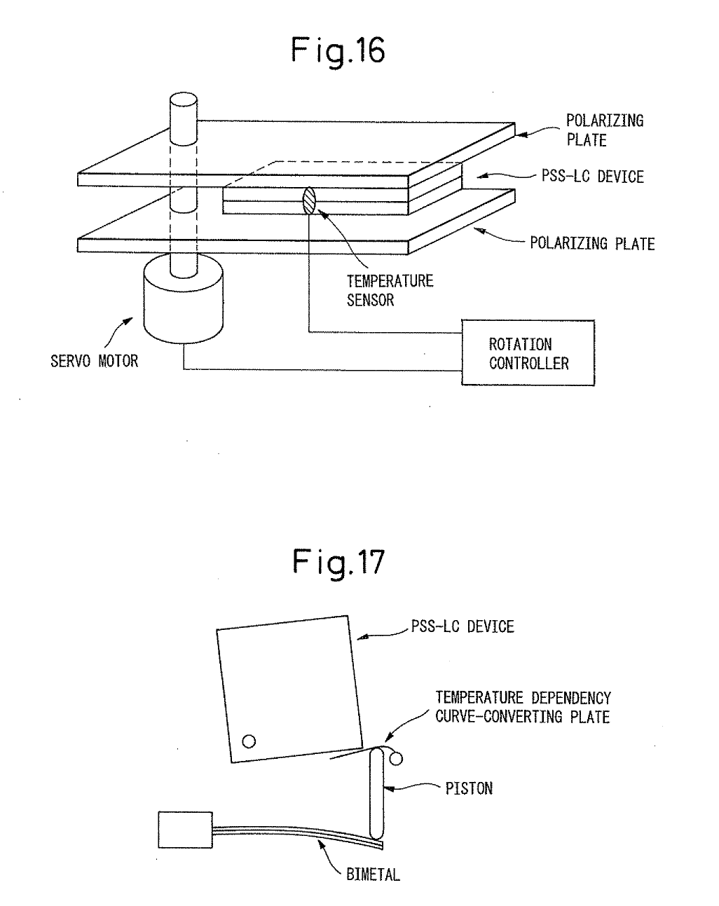

For example, a method of rotating the polarizing plate by a servo motor shown in FIG. 16, and a method of rotating the element by means of a piezoelectric element may be employed as the rotation mechanism. As one example of the rotation angle adjustment in this case, the case of using a servo motor of FIG. 16 that is one example of the construction in the schematic side view of FIG. 14 is described.

Referring to FIG. 16, a PSS-LCD element is disposed between perpendicularly arranged polarizing plates. To this PSS-LCD element, a temperature sensor element such as thermistor or platinum resistance element is equipped to sequentially acquire the temperature information of the PSS-LCD element. The acquired temperature information is compared with the angle information of the perpendicularly arranged polarizing plates with respect to the PSS-LCD element for the measured temperature, which is recorded in the control part.

The angle information recorded in the control part is the information prepared by previously measuring the angle giving a minimum transmitted light quantity in the light-shielding state of the PSS-LCD element for the measured temperature. Accordingly, by controlling the rotation of the servo motor to tilt the perpendicularly arranged polarizing plates at the matched angle, a condition providing a minimum transmitted light quantity in the light-shielding state can be reproduced.

As another example, the construction in the schematic side view of FIG. 15 is described. A PSS-LCD element is disposed between perpendicularly arranged polarizing plates. On the light outgoing side, an optical sensor element such as photodiode or phototransistor is fixed to allow the transmitted light to be incident thereinto and sequentially acquires the transmitted light quantity information. There is performed a feedback control of judging from the acquired transmitted light quantity whether a minimum transmitted light quantity is provided in the light-shielding state, and if the case is not so, rotating the PSS-LCD element by an actuator, thereby again acquiring the transmitted light quantity. By employing such a construction, the light-shielding state can be constantly kept in the optimal state.

In the case where the element temperature change is not sharp, the control operation frequency decreases and there arises substantially no problem in terms of abrasion, vibration and noise due to rocking of the mechanical mechanism.

### (Utilization of Element Undergoing Displacement of Contour)

In addition to the above-described mechanical system, by utilizing an element of which contour is displaced depending on the temperature, the polarizing plate or liquid crystal element can be rotated or tilted at the same time with temperature measurement.

As one example of the construction utilizing such an element of which contour is displaced, the construction in the schematic view of FIG. 17 is described. Referring to FIG. 17, a bimetal is utilized as the actuator for rotating the PSS-LCD or polarizing plate in FIG. 14 or 15. The bimetal is an element obtained by laminating together two metal sheets differing in the coefficient of thermal expansion and has a property of being deformed according to the temperature. Since the deformation amount depends on the temperature, this element is used in a thermometer or a temperature control device.

Similarly to such a device, by utilizing the temperature-related deformation as an actuator, the polarizing plate or PSS-LCD can be rotated or tilted at the same time with temperature measurement.

In the schematic view of FIG. 17, the bimetal is disposed to undergo a displacement due to temperature and thereby move a piston up or down. Even if the polarizing plate or PSS-LCD is rotated by transmitting this movement directly thereto, because of a difference in the temperature dependency between the bimetal and the PSS-LCD, the transmitted light quantity cannot be controlled to the minimum in the light-shielding state. For this reason, a temperature dependency curve-converting plate that allows the displacement of the bimetal to correspond to the temperature dependency curve of PSS-LCD, is inserted between the piston and the PSS-LCD. By employing such a construction, the transmitted light quantity in the light-shielding state can be controlled to the minimum while completely eliminating an electric signal circuit in the temperature compensation portion. This method is advantageous in that the structure is simple and since an electric circuit-related failure can be completely eliminated, the reliability is high.

### (Manual Adjustment)

In the case where the change of the element temperature occurs at a low frequency, the transmitted light quantity in the light-shielding state can be minimized also by manually rotating and/or tilting the polarizing plate or liquid crystal element while observing the transmitted light quantity in the light-shielding state with an eye. Furthermore, in the case where the temperature of the element used is fixed, the transmitted light quantity in the light-shielding state can be minimized by preparing a polarizing plate or liquid crystal element previously rotated or tilted in agreement with the temperature of the element used and refixing it according to the temperature of the element used.

The fundamental concept of the above-described liquid crystal device according to the present invention is to fabricate, for example, a liquid crystal device (for example, having an optical shutter function) construction by utilizing a specific electro-optical response of the liquid crystal material (for example, PSS-LCD) used and thereby enable an optical shutter with high transmittance, high light-blocking ratio and high contrast ratio while keeping the high-speed responsivity. In the description above, for the convenience sake, an embodiment using PSS-LCD is mainly described, but irrespective of PSS-LCD, the method of the present invention can be applied as long as the liquid crystal material is a material capable of constituting an electro-optical element in which the optical axis azimuth is rotated in response to the strength and/or direction of an electric field to be applied thereto for applying the system above of the present invention. From the standpoint of more effectively bringing out the effects of the present invention, a liquid crystal material enabling a sufficiently high-speed response time is preferred.

### (Polarizing Element)

As for the polarizing element usable in the present invention, a polarizing element conventionally used for fabricating a liquid crystal device can be used without any particular limitation. The shape, size, constituent element and the like thereof are also not particularly limited.

### (Suitable Polarizing Element)

Examples of the polarizing element which can be suitably used in the present invention include the following:

π-Cell: Molecular Crystals and Liquid Crystals, Vol. 113, page 329 (1984), Phil Bos and K. R. Kehler-Beran

### (Liquid Crystal Element)

The liquid crystal element according to an embodiment of the present invention comprises a pair of substrates and a liquid crystal material disposed between the pair of substrates.

### (Liquid Crystal Material)

In the present invention, a liquid crystal material can be used without any particular limitation as long as it is a liquid crystal material capable of constituting an electro-optical element in which the optical axis azimuth is rotated in response to the strength and/or direction of an electric field to be applied thereto for applying the system of the present invention. Whether or not a certain liquid crystal material is usable in the present invention can be confirmed by the following “Confirmation Method for Optical Axis Azimuth Rotation”. Also, in the present invention, a liquid crystal material capable of a predetermined high-speed response is suitably usable and whether or not a certain liquid crystal material can response at a sufficiently high speed can be confirmed by the following “Confirmation Method for Response Time”.

### (Confirmation Method for Optical Axis Azimuth Rotation)

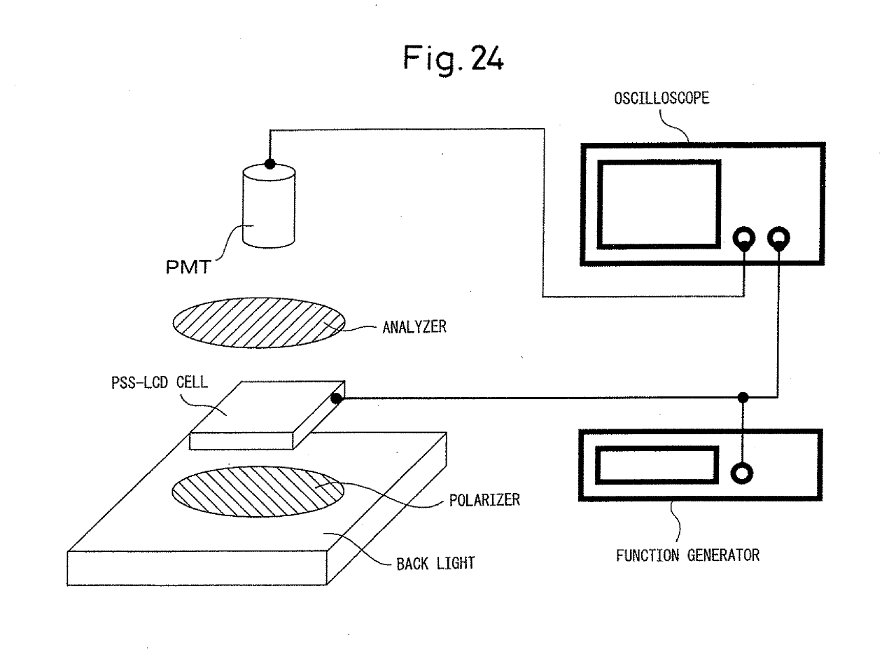

In regard to the method for measuring the optical axis azimuth rotation as a liquid crystal element, in the case of disposing a liquid crystal element in the cross-Nicol arrangement where a polarizer is disposed perpendicularly to an analyzer, when the optical axis agrees with the absorption axis of the analyzer, the. intensity of transmitted light becomes minimum. Accordingly, the angle at which the minimum intensity of transmitted light in the cross-Nicol arrangement is obtained becomes the angle of optical axis azimuth. At this time, an electric field is not applied to the liquid crystal element. Using this angle as a reference angle, an angle at which the minimum intensity of transmitted light in the cross-Nicol arrangement is obtained when applying an electric field to the liquid crystal element is sought for. When an angle giving a minimum intensity upon application of an electric field is present and the angle giving a minimum intensity is an angle slipped from the reference angle and when the strength or direction of the electric field is varied and an increase or decrease of the rotation angle in accordance with the variation is observed, it can be confirmed that the optical axis direction is rotated. As regards the apparatus for confirmation, similarly to the confirmation method for optical axis azimuth, the rotation can be confirmed, for example, by an apparatus having a construction of FIG. 24.

### (Confirmation Method for Response Time)

In the case where optical axis azimuth rotation is observed in the liquid crystal element, the speed of this rotation comes under the response time. A liquid crystal element is disposed at an angle giving a minimum transmitted light quantity in the cross-Nicol arrangement where a polarizer is disposed perpendicularly to an analyzer, and an electric field is applied to the liquid crystal element. The optical axis azimuth is rotated upon application of an electric field and therefore, the transmitted light quantity is changed. The degree of change in the transmitted light quantity becomes the degree of change in the rotation. Assuming that the transmitted light quantity in the state of an electric field being not applied is 0% and the transmitted light quantity that is changed by the application of an electric field and finally reaches a steady state is 100%, the time necessary for the transmitted light quantity to rise from 10% to 90% when an electric field is applied from the state of an electric field being not applied is designated as a rise-up response time, and the time necessary for the transmitted light quantity to drop from 90% to 10% when application of an electric field is stopped from the state of an electric field being applied is designated as a rise-down response time. For example, in PSS-LCD, the rise-up response time and the rise-down response time both are about 400 μs. As regards the apparatus for confirmation, similarly to “Confirmation Method for Optical Axis Azimuth”, the response time can be confirmed, for example, by an apparatus having a construction of FIG. 24.

The liquid crystal material which is preferably usable in the present invention is a PSS-LC, wherein the molecular initial alignment in the liquid crystal material has an almost parallel direction with respect to the alignment treatment direction; and the liquid crystal material shows substantially no spontaneous polarization which is at least perpendicular to a pair of substrates, under the absence of an externally applied voltage.

### (Molecular Initial Alignment)

In the present invention, in the molecular initial alignment (or orientation) in the liquid crystal material, the major axis of the liquid crystal molecules has an almost parallel direction with respect to the alignment treatment direction for the liquid crystal molecules. The fact that the major axis of the liquid crystal molecules has an almost parallel direction with respect to the alignment treatment direction can be confirmed, e.g., by the following manner.

In order to enable the liquid crystal device according to the present invention to exhibit a desirable display performance, the angle (the number as absolute value) between the rubbing direction and the alignment direction of the liquid crystal molecules, which has been measured by the following method may preferably be 3 degrees or less, more preferably be 2 degrees or less, particularly 1 degree or less.

In a strict sense, it is known that when a polymer alignment film such as polyimide film is subjected to rubbing, a birefringence is induced in the polyimide outermost layer, to thereby provide a slow optical axis. Further, in general, it is known that the major axis of the liquid crystal molecules are aligned in parallel with the slow optical axis. With respect to almost all of the polymer alignment films, it is known that a certain gap in the angle occurs between the rubbing direction and the slow optical axis. In general, the gap is relatively small and may be about 1-7 degrees.

However, this gap in the angle can be 90 degrees as in the case of polystyrene as an extreme example.

Therefore, in the present invention, the angle between the rubbing direction and the alignment direction of the major axis (i.e., optical axis) of the liquid crystal molecules may preferably be 3 degrees or less. At this time, the alignment direction of the major axis of the liquid crystal molecules, and the slow optical axis which has been provided in the polymer (such as polyimide) polymer alignment film by rubbing, etc., may preferably be 3 degrees or less, more preferably 2 degrees or less, particularly 1 degree or less.

As described above, in the present invention, the alignment treatment direction refers to the direction of the slow optical axis (in the polymer outermost layer) which determines the direction of the alignment of the liquid crystal molecule major axis.

### <Method of Measuring Molecular Initial Alignment State for Liquid Crystal Molecules>

In general, the major axis of liquid crystal molecules is in fair agreement with the optical axis. Therefore, when a liquid crystal panel is placed in a cross Nicole arrangement wherein a polarizer is disposed perpendicular to an analyzer, the intensity of the transmitted light becomes the smallest when the optical axis of the liquid crystal is in fair agreement with the absorption axis of the analyzer. The direction of the initial alignment axis can be determined by a method wherein the liquid crystal panel is rotated in the cross Nicole arrangement while measuring the intensity of the transmitted light, whereby the angle providing the smallest intensity of the transmitted light can be determined.

<Method of Measuring Parallelism of Direction of Liquid Crystal Molecule Major Axis with Direction of Alignment Treatment>

The direction of rubbing is determined by a set angle, and the slow optical axis of a polymer alignment film outermost layer which has been provided by the rubbing is determined by the kind of the polymer alignment film, the process for producing the film, the rubbing strength, etc. Therefore, when the extinction position is provided in parallel with the direction of the slow optical axis, it is confirmed that the molecule major axis, i.e., the optical axis of the molecules, is in parallel with the direction of the slow optical axis.

### (Spontaneous Polarization)

In the present invention, in initial molecular alignment, the spontaneous polarization (which is similar to the spontaneous polarization in the case of a ferroelectric liquid crystal) is not generated, at least with respect to the direction which is perpendicular to the substrate. In the present invention, the “initial molecular alignment providing substantially no spontaneous polarization is such that the spontaneous polarization does not occur” can be confirmed, e.g., by the following method.

### <Method of Measuring Presence of Spontaneous Polarization Perpendicular to the Substrate>

In a case where the liquid crystal in a liquid crystal cell has a spontaneous polarization, particularly in a case where a spontaneous polarization is generated in the substrate direction in the initial state, namely in the direction perpendicular to the electric field direction in the initial state (i.e., under the absence of an external electric field), when a low-frequency triangular voltage (about 0.1 Hz) is applied to the liquid crystal cell, the direction of the spontaneous polarization is reversed from the upper direction into the lower direction, or from the lower direction into the upper direction, along with the change of the polarity of the applied voltage from positive into negative, or from negative into positive. Along with such an inversion, actual electric charge is transported (i.e., an electric current is generated). The spontaneous polarization is reversed, only when the polarity of the applied electric field is reversed. Therefore, there appears a peak-shaped electric current as shown in FIG. 20.

The integral value of the peak-shaped electric current corresponds to the total quantity electric charges to be transported, i.e., the strength of the spontaneous polarization. When no peak-shaped electric current is observed in this measurement, the absence of the occurrence of the spontaneous polarization inversion is directly proved by such a phenomenon.

Further, when a linear increase in the electric current as shown in FIG. 21 is observed, it is found that the major axis of the liquid crystal molecules is continuously or consecutively changed in the molecular alignment direction thereof, depending on the increase in the electric field intensity. In other words, in this case as shown in FIG. 21, it has been found that there occurs a change in the molecular alignment direction due to induced polarization, etc., depending on the intensity of the applied electric field.

### (Substrate)

The substrate usable in the present invention is not particularly limited, as long as it can provide the above-mentioned specific “molecular initial alignment state”. In other words, in the present invention, a suitable substrate can appropriately be selected, in view of the usage or application of LCD, the material and size thereof, etc. Specific examples thereof usable in the present invention are as follows.

A glass substrate having thereon a patterned a transparent electrode (such as ITO)

An amorphous silicon TFT-array substrate

A low-temperature poly-silicon TFT array substrate

A high-temperature poly-silicon TFT array substrate

A single-crystal silicon array substrate

### (Preferred Substrate Examples)

Among these, it is preferred to use following substrate, in a case where the present invention is applied to a large-scale liquid crystal display panel.

An amorphous silicon TFT array substrate (PSS-LC material)

The PSS-LC material usable in the present invention is not particularly limited as long as it can provide the above-mentioned specific “molecular initial alignment state”. In other words, in the present invention, a suitable liquid crystal material can appropriately be selected, in view of the physical property, electric or display performance, etc. For example, various liquid crystal materials (including various ferroelectric or non-ferroelectric liquid crystal materials) as exemplified in a publication of may generally be used in the present invention. Specific preferred examples of such liquid crystal materials usable in the present invention are as follows.

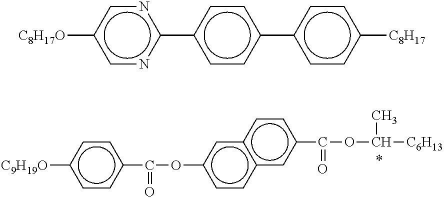

### (Preferred Liquid Crystal Material Examples)

Among these, it is preferred to use the following liquid crystal material, in a case where the present invention is applied to a projection-type liquid crystal display.

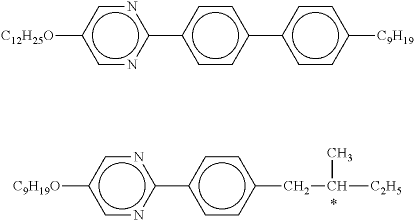

### (Alignment Film)

The alignment film usable in the present invention is not particularly limited as long as it can provide the above-mentioned specific “molecular initial alignment state”. In other words, in the present invention, a suitable alignment film can appropriately be selected, in view of the physical property, electric or display performance, etc. For example, various alignment films as exemplified in publications may generally be used in the present invention. Specific preferred examples of such alignment films usable in the present invention are as follows.

Polymer alignment film: polyimides, polyamides, polyimide-imides

Inorganic alignment film: SiO2, SiO, Ta205, etc.

### (Preferred Alignment Film Examples)

Among these, it is preferred to use the following alignment film, in a case where the present invention is applied to a projection-type liquid crystal display.

Inorganic Alignment Films

In the present invention, as the above-mentioned substrates, liquid crystal materials, and alignment films, it is possible to use those materials, components or constituents corresponding to the respective items as described in “Liquid Crystal Device Handbook” (1989), published by The Nikkan Kogyo Shimbun, Ltd. (Tokyo, Japan), as desired.

### (Other Constituents)

The other materials, constituents or components, such as transparent electrode, electrode pattern, micro-color filter, spacer, and polarizer, to be used for constituting the liquid crystal display according to the present invention, are not particularly limited, unless they are against the purpose of the present invention (i.e., as long as they can provide the above-mentioned specific “molecular initial alignment state”). In addition, the process for producing the liquid crystal display device which is usable in the present invention is not particularly limited, except the liquid crystal display device should be constituted so as to provide the above-mentioned specific “molecular initial alignment state”. With respect to the details of various materials, constituents or components for constituting the liquid crystal display device, as desired, “Liquid Crystal Device Handbook” (1989), published by The Nikkan Kogyo Shimbun, Ltd. (Tokyo, Japan) may be referred to.

### (Means for Realizing Specific Initial Alignment)

The means or measure for realizing such an alignment state is not particularly limited, as long as it can realize the above-mentioned specific'molecular initial alignment state”. In other words, in the present invention, a suitable means or measure for realizing the specific initial alignment can appropriately be selected, in view of the physical property, electric or display performance, etc.

The following means may preferably be used, in a case where the present invention is applied to a large- sized TV panel, a small-size high-definition display panel, and a direct-view type display.

### (Preferred Means for Providing Initial Alignment)

According to the present inventors' investigation and knowledge, the above-mentioned suitable initial alignment may easily be realized by using the following alignment film (in the case of baked film, the thickness thereof is shown by the thickness after the baking) and rubbing treatment. On the other hand, in ordinary ferroelectric liquid crystal displays, the thickness of the alignment film 3,000 A (angstrom) or less, and the strength of rubbing (i.e., contact length of rubbing) 0.3 mm or less.

Thickness of alignment film: preferably 4,000 A or more, more preferably 5,000 A or more (particularly, 6,000 A or more)

Strength of rubbing (i.e., contact length of rubbing): preferably 0.3 mm or more, more preferably 0.4 mm or more (particularly, 0.45 mm or more)

The above-mentioned alignment film thickness and strength of rubbing may be measured, e.g., in a manner as described in Production Example 1 appearing hereinafter

### Usable PSS-LCD; Another Embodiment 1

According to another embodiment, there is provided:

a liquid crystal device (i.e., PSS-LCD) comprising: at least, a pair of substrates; a liquid crystal material disposed between the pair of substrates; and a pair of polarizing films disposed on the outside of the pair of substrates; wherein one of the pair of polarizing films has a molecular initial alignment which is parallel or almost parallel with the alignment treatment direction for the liquid crystal material; the other of the pair of polarizing films has a polarizing absorption direction which is perpendicular to the alignment treatment direction for the liquid crystal material; and, the liquid crystal device shows an extinction angle under the absence of an externally applied voltage.

The liquid crystal display according to such an embodiment has an advantage that the extinction position thereof does not substantially have a temperature dependency, in addition to those as described above.

Therefore, in this embodiment, it is possible to make the temperature dependency of the contrast ratio relatively small.

In the above-mentioned relationship wherein the polarizing absorption axis direction of the polarizing film is substantially aligned with the alignment treatment direction of the liquid crystal material, the angle between the polarizing absorption axis direction of the polarizing film and the alignment treatment direction of the liquid crystal material may preferably be 2 degrees or less, more preferably 1 degree or less, particularly 0. 5 degree or less.

In addition, the phenomenon that the liquid crystal device shows an extinction position under the absence of an externally applied voltage may be confirmed, e.g., by the following method.

### <Method of Confirming Extinction Position>

A liquid crystal panel to be examined is inserted between a polarizer and an analyzer which are arranged in cross-Nicole relationship, and the angle providing the minimum light quantity of the transmitted light is determined while the liquid crystal panel is being rotated. The thus determined angle is the angle of the extinction position.

### Usable PSS-LCD; Another Embodiment 2

According to a further embodiment, there is provided: a liquid crystal device (i.e., PSS-LCD) comprising: at least, a pair of substrates; and a liquid crystal material disposed between the pair of substrates; wherein the current passing through the pair of substrates shows substantially no peak-shaped current, when a continuously and linearly changing voltage waveform is applied to the liquid crystal device.

The current passing through the pair of substrates does not substantially show a peak-shaped current, under the application of a voltage waveform of which strength is continuously and linearly changed, may be confirmed, e.g., by the following method.

In this embodiment, “the current does not substantially show a peak-shaped current” means that, in the liquid crystal molecule alignment change, the spontaneous polarization does not participate in the liquid crystal molecule alignment change, at least in a direct manner. The liquid crystal display according to such an embodiment has an advantage, in addition to those as described above, that it enables sufficient liquid crystal driving, even in a device having the lowest electron mobility such as amorphous silicon TFT array device among active driving devices.

Even when the liquid crystal per se can exhibit a considerably high display performance, if the capacity thereof is relatively large, it is difficult to drive such a liquid crystal by using an amorphous silicon TFT array device having a limit on the electron mobility. As a result, it is actually impossible to provide high-quality display performance. Even in this case, in view of the ability of driving the liquid crystal, it is possible to provide sufficient display performance, by using low-temperature polysilicon and high-temperature polysilicon TFT array devices having a lager electron mobility than amorphous silicon; or single crystal silicon (silicon wafer) capable of providing the maximum electron mobility.

On the other hand, the amorphous silicon TFT array is economically advantageous in view of the production cost. Further, when the size of the panel is increased, the economic advantage of the amorphous silicon TFT array is much greater than the other types of active devices.

### <Method of Confirming Peak-Shaped Current>

A triangular wave voltage having an extremely low frequency of about 0.1 Hz is applied to a liquid crystal panel to be examined. The liquid crystal panel would sense such an applied voltage so that a DC voltage is increased and decreased almost linearly. When the liquid crystal in the panel shows a ferroelectric liquid crystal phase, the optical response, and charge transfer state are dependent on the polarity of the triangular wave voltage, but not substantially dependent on the crest value (or peak-to-peak value) of the triangular wave voltage. In other words, **due** to the presence of the spontaneous polarization, the spontaneous polarization of the liquid crystal is coupled with the externally applied voltage, only when the polarity of the applied voltage is changed from negative to positive, or from positive to negative. When the spontaneous polarization is reversed, electric charges are temporarily transferred so as to generate a peak-shaped electric current in the inside of the panel. On the contrary, if the reverse of the spontaneous polarization does not occur, no peak-shaped electric current is observed, and the current shows a monotonous increase, decrease or a constant value.

Therefore, the polarization of the panel may be determined by applying a low-frequency triangular wave voltage to the panel and precisely **measuring** the resultant current, to thereby determine the profile of the current wave form.

### Usable PSS-LCD; Another Embodiment 3

According to a further embodiment of the present invention, there is provided: a liquid crystal device (i.e., PSS-LCD) wherein the liquid crystal molecular alignment treatment for the liquid crystal material is conducted in conjunction with a liquid crystal molecular alignment material providing a low surface pre-tilt angle.

In this embodiment, the pre-tilt angle may preferably be 1.5 degrees or less, more preferably 1.0 degree or less (particularly 0.5 degree or less). The liquid crystal display according to such an embodiment has an advantage, in addition to those describe above, that it can provide uniform alignment in a wide area, and a wide view angle.

The reason why the wide view angle is provided is as follows.

In the liquid crystal molecule alignment according to the present invention, liquid crystal molecules may be moved within cone-like regions, and the electro-optical response thereof does not remain in the same plane.

Generally, when such molecular movement out of the plane is caused, the incidence angle dependency of birefringence occurs, and the viewing angle is narrowed. However, in the liquid crystal molecule alignment according to the present invention, the molecular optical axis of liquid crystal molecules may always be moved in the clockwise or counter-clockwise direction, symmetrically and at a high-speed, with respect of the top of cones, as shown in FIG. 22. Due to the high-speed symmetrical movement, an extremely symmetrical image may be obtained as a result of time-averaging.

Therefore, with respect to the **view** angle, this embodiment can provide images having high symmetry and a small angle dependency.

### Usable PSS-LCD; Another Embodiment 4

According to a further embodiment of the present invention, there is provided: a liquid crystal device (i.e., PSS-LCD) wherein the liquid crystal material shows Smectic A phase to the ferroelectric liquid crystal phase sequence.

In this embodiment, the phenomenon that the liquid crystal material has a “Smectic A phase to the ferroelectric liquid crystal phase sequence” can be confirmed, e.g., by the following method. The liquid crystal display according to such an embodiment has an advantage, in addition to those as described above, that it can provide a higher upper limit of the storage temperature therefor. More specifically, in a case where the upper limit of the storage temperature for the liquid crystal display is intended to be determined, even when the temperature exceeds the transition temperature for the ferroelectric liquid crystal phase to Smectic A phase, it can return to the ferroelectric liquid crystal phase so as to restore the initial molecular alignment, unless the temperature exceeds the transition temperature for the smectic A phase to cholesteric phase.

### <Method of Confirming Phase Transition Sequence>

The phase transition sequence of the smectic liquid crystal may be confirmed as follows.

Under a cross Nicole relationship, the temperature of a liquid crystal panel is lowered from the isotropic phase temperature. At this time, the buffing direction is made in parallel with the analyzer. As a result of the observation by a polarizing microscope, a birefringence change wherein a firework-like shape is changed into a round shape is first measured. When the temperature is further decreased, an extinction direction occurs in parallel with the buffing direction. When the temperature is further decreased, and the phase is converted into a so-called ferroelectric liquid crystal phase. In this phase, when the panel is rotated by an angle of 3-4 degree around in the vicinity of the extinction position, it is found that the transmitted light intensity is increased when the position is outside of the extinction position, along with a decrease in the temperature.

Herein, it is possible to confirm the helical pitch of a ferroelectric liquid crystal phase and the panel gap of the substrates, e.g., by the following method.

### <Method of Confirming Helical Pitch>

In a cell having substrates which have been buffed so as to provide alignment treatments in parallel with each other, a liquid crystal material is injected between panels having a cell gap which is at least five times the expected helical pitch. As a result, a striped pattern corresponding to the helical pitch appears in the display surface.

### <Method of Confirming Panel Gap>

Before the injection of a liquid crystal material, the panel gap may be measured by using a liquid crystal panel gap measuring device utilizing light interference.

### (Measuring Method for Optical Axis Azimuth Angle and Construction of Apparatus)

In regard to the method for exactly measuring the optical axis azimuth as a liquid crystal element, in the case of disposing a liquid crystal element in the cross-Nicol arrangement where a polarizer is disposed perpendicularly to an analyzer, when the optical axis agrees with the absorption axis of the analyzer, the intensity of transmitted light becomes minimum. Accordingly, the angle at which the minimum intensity of transmitted light in the cross-Nicol arrangement is obtained becomes the angle of optical axis azimuth. Example of the measuring apparatus include a polarizing microscope equipped with a photodetection element such as PMT (photomultiplier tube) in the tube part.

The schematic perspective view of FIG. 24 shows one example of the construction of components suitable for the exact measurement of optical axis azimuth. The polarizer and analyzer of the polarizing microscope are laid in the cross-Nicol arrangement, a liquid crystal element to be measured is disposed on the sample stage by arranging the reference angle to be the same as the absorption axis angle of the analyzer, and the sample stage is rotated to make minimum the light quantity detected by PMT. The angle of the sample stage here becomes the optical axis azimuth angle with respect to the reference angle of the liquid crystal element.

Hereinbelow, the present invention will be described in more detail with reference to specific Production Examples and Examples.

### EXAMPLES

### Production Example 1

Using commercially available FLC mixture material (Merck: ZLI-4851-100), photo-curable liquid crystalline material (Dai-Nippon Ink Chemicals: UCL-001), and photo initiator material (Merck: Darocur 1173), based on JP-A H11-21554 (Japanese Paten Appln. H09-174463), PS- V-FLCD panel was fabricated. The mixture had 93 mass % of ZLI-4851-100 FLC mixture, 6 mass % of UCL-001, and 1 mass % Darocur 1173.

The substrate used herein was a glass substrate (borosilicate glass, thickness 0.7 mm, size: 50 mm×50 mm; available from Nano Loa Inc.) having thereon an ITO film.

The polyimide alignment film was formed by applying a polyimide alignment material by use of a spin coater, then preliminarily baking the resultant film, and finally baking the resultant product in a clean oven. With respect to the details of the general industrial procedure to be used herein, as desired, a publication “Liquid Crystal Display Techniques”, Sangyo Tosho (1996, Tokyo), Chapter 6 may be referred to.

For the liquid crystal molecular alignment material, RN-1199 (Nissan Chemicals Industries) was used as 1 to 1.5° of pre-tilt angle alignment material. Thickness of the alignment layer as cured layer was set at 4,500 A to 5,000 A. The surface of this cured alignment layer was buffed by Rayon cloth (mfd. by Yoshikwa Kako, trade name 19RY) in the direction of an angle of 30 degrees to center line of the substrate shown in FIG. 23. The contact length of the buffing was set to 0.5 mm at both substrates. In FIG. 23, the angle shown in the “laminated panel” is a buffing angle for the laminated panel.

### <Buffing Conditions>

Contact length of the buffing: 0.5 mm

Number of buffing: once

Stage moving speed: 2 mm/sec.

Roller rotational frequency: 1000 rpm (R=40 mm)

Silicon dioxide balls with average diameter of 1.6 μm are used as spacer. Obtained panel gap as measured was 1.8 μm. The above mixed material was injected into the panel at the isotropic phase temperature of 110° C.

After the mixed material was injected, ambient temperature was controlled to reduce 2° C. per minute till the mixed material showed ferroelectric phase (40° C.).

Then by natural cooling, after the panel reached room temperature, the panel was applied with +/−10 V, 500 Hz of triangular waveform, 10 minutes (by use of a function generator, mfd. by NF Circuit Block Co., trade name: WF1946F). After 10 minutes voltage application, 365 nm of UV light was exposed keeping application of the same voltage (by use of a UV light, mfd. by UVP Co., trade name: UVL-56). The exposure power was set to 5,000 mJ/cm2. With respect to the details of the general industrial procedure to be used herein, as desired, a publication “Liquid Crystal Display Techniques”, Sangyo Tosho (1996, Tokyo), Chapter 6 may be referred to.

The initial molecular alignment direction of this panel was same with the buffing direction. The electro-optical measurement of this panel showed analog gray scale by application of triangular waveform voltage.

With respect to the details of the general industrial procedure to be used herein, as desired, a publication “The Optics of Thermotropic Liquid Crystals”, Taylor and Francis: 1998, London UK; Chapter 8 and Chapter 9 may be referred to.

### Production Example 2

For the liquid crystal molecular alignment material,

RN-1199 (Nissan Chemicals Industries) was used as 1 to 1.5° of pre-tilt angle alignment material. Thickness of the alignment layer as cured layer was set at 6,500 A to 7,000 A. The surface of this cured alignment layer was buffed by Rayon cloth in the direction of 30 degrees to center line of the substrate shown in FIG. 23. The contact length of the buffing was set to 0.5 mm at both substrates. Silicon dioxide balls with average diameter of 1.6 μm are used as spacer. Obtained panel gap as measured was. 1.8 μm. In this panel, commercially available FLC mixture material (Merck: ZLI-4851-100) was injected at the isotropic phase temperature of 110° C.

After the mixed material was injected, ambient temperature was controlled to reduce 1° C. per minute till the FLO material showed ferroelectric phase (40° C.). In this slow cooling process, from Smectic A phase to Chiral Smectic C phase (75° C. to 40° C.), +/−2 V, 500 Hz of triangular waveform voltage was applied. After panel temperature reached 40° C., applied triangular waveform voltage was increased to +/−10V. Then using natural cooling, panel temperature was cooled down to room temperature with voltage application. The initial molecular alignment direction of this panel was same with the buffing direction in most of the observed area, however, in a very limited area showed +/−20 deg. shifted from the buffing angle. The electro-optical measurement of this panel showed analog gray scale switching as ×20 magnification field average at polarized microscope observation.

In this production example, it was found that too large voltage application at the slow cooling process degrades initial FLC molecular alignment. For instance, at the temperature the panel shows Smectic A phase, over +/−5V voltage is applied, there shows stripe alignment defect along with buffing direction. Once this type of defect happens, voltage application at Chiral smectic C phase (the ferroelectric liquid crystal phase) does not eliminate the defect. The voltage application at the slow cooling is effective, but its condition should be strictly controlled. In these examples showed that at Smectic A phase, up to 1 V/μm, from Smectic A phase to 10° C. below the Smectic A to Chiral SmC phase transition temperature, up to 1.5 V/μm, below 20° C. from the phase transition temperature, up to 5 V/μm, then lower than this temperature, up to 7.5 V/μm are preferred to obtain good result.

### Production Example 3

The liquid crystal molecular alignment material, RN-1199 (Nissan Chemicals Industries) was used as 1 to 1.5 degree of pre-tilt angle alignment material. Thickness of the alignment layer as cured layer was set at 6,500 A to 7, 000 A. The surface of this cured alignment layer was buffed by Rayon cloth in the direction of an angle of 30 degrees to center line of the substrate shown in FIG. 23. The contact length of the buffing was set to 0.6 mm at both substrates. Silicon dioxide balls with average diameter of 1.8 μm are used as spacer. Obtained panel gap as measured was 2.0 μm. In this panel, Naphthalene base FLC material described in Molecular Crystals and The liquid crystals; “Naphthalene Base Ferroelectric liquid crystal and Its Electro Optical Properties”; Vol. 243, pp. 77-pp. 90, (1994). was injected at the isotropic phase temperature of 130° C. This FIE material's helical pitch at room temperature was 2.5 μm.

After the material was injected, ambient temperature was controlled to reduce 1° C. per minute from 130° C. to 50° C. which shows ferroelectric phase. In this slow cooling process, from Smectic A phase to Chiral Smectic C phase (90° C. to 50° C.), +/−1 V, 500 Hz of triangular waveform voltage was applied. After panel temperature reached 50° C., applied triangular waveform voltage was increased to +/−7V.

Then using natural cooling, panel temperature was cooled down to room temperature with voltage application. The initial molecular alignment direction of this panel was same with the buffing direction in most of the view area.

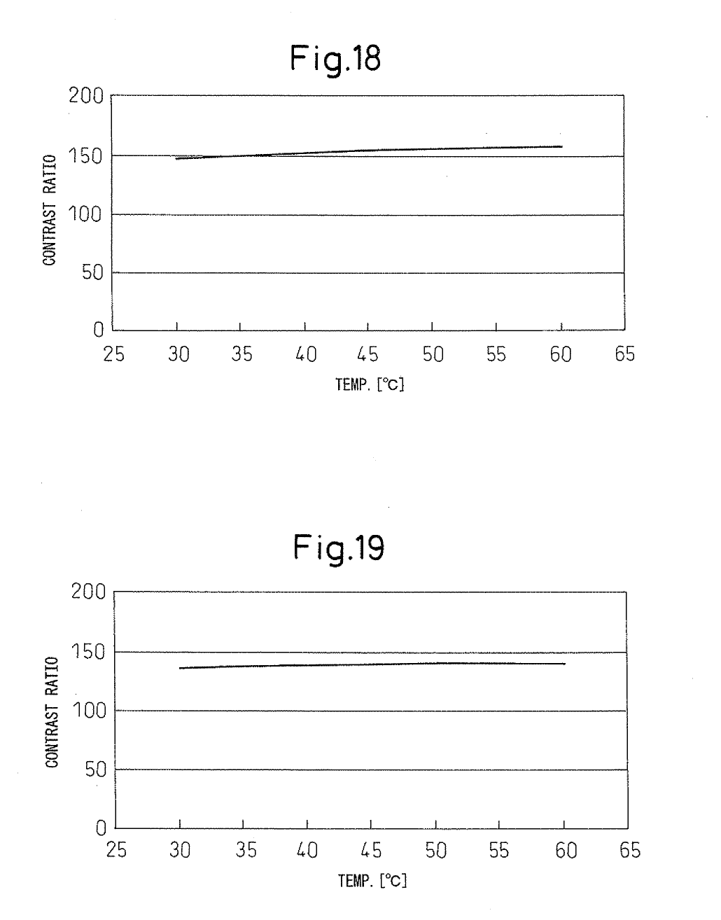

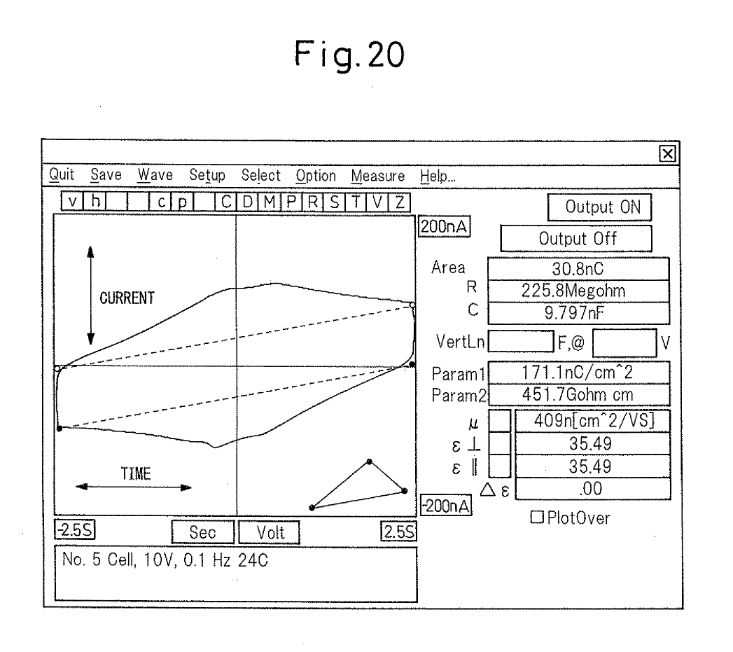

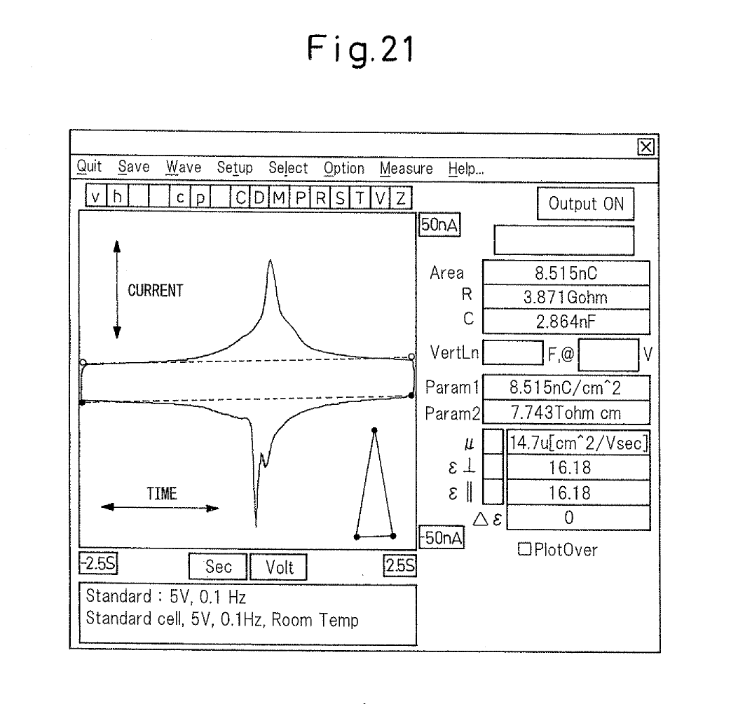

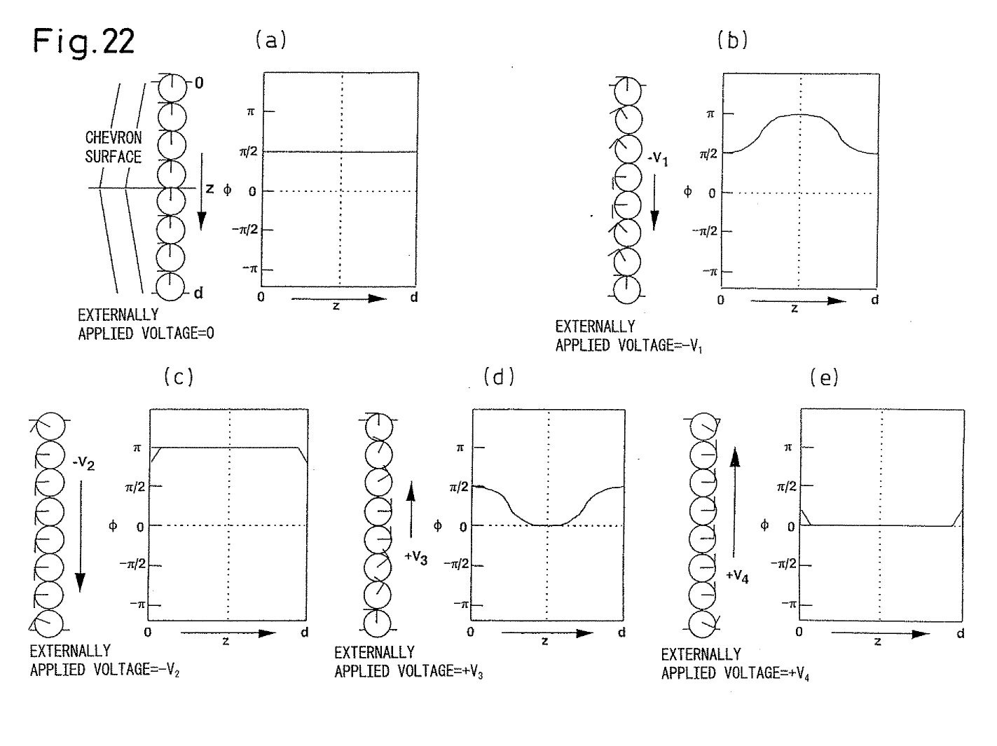

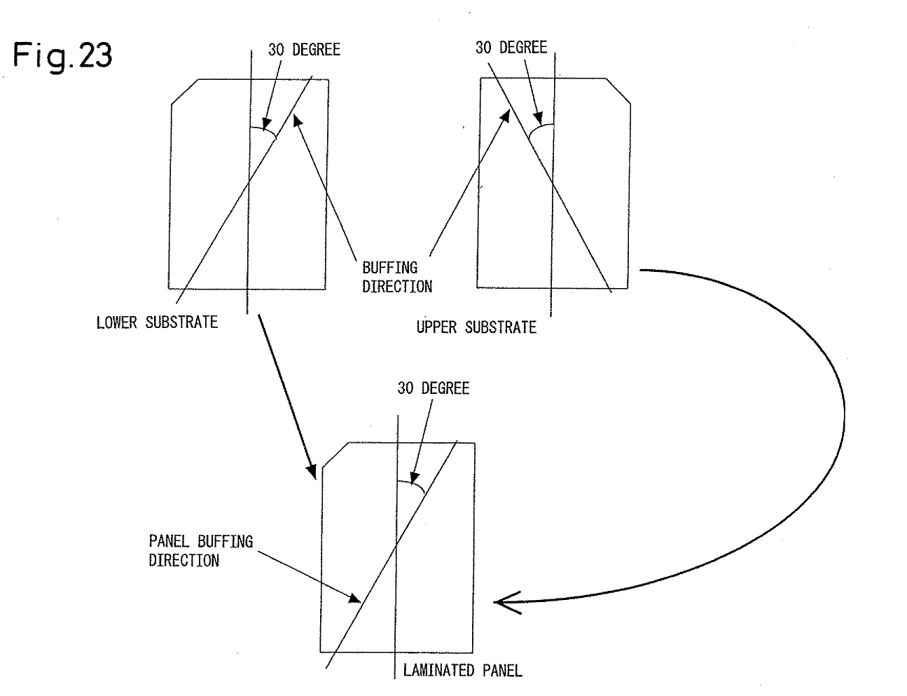

Only small slight area, +/−17 deg. shifted from the buffing angle was observed. The electro-optical measurement of this panel showed analog gray scale switching as an average of the ×20 magnification field at polarized microscope observation as shown in FIG. 19. In this production example, it was also found that the applied voltage waveform during slow cooling was not limited in triangular waveform, but sine waveform, rectangular waveform were also effective to stabilize the initial molecular alignment parallel to the buffing direction.

The results obtained in the above Examples are summarized in the following Table 1.

TABLE 1
Wrap-up of Production examples

| | | | Alignment conditions | | | | | |
|---|---|---|---|---|---|---|---|---|
| | Photo- | | Pure- | Alignment | Buffing | Temperature | | |
| | sensitive | Base FLC | tilt | layer thickness | contact | reduction | Voltage application conditions | |
| Example | material | material | (deg.) | (A) | length (mm) | rate (δ/min) | Higher temperature | Lower temperature |
| Ex. 1 | Yes | ZLI-4851-100 | 1 | 5,000 | 0.5 | 2 | No | ±10 V, 500 Hz, Triangular |
| Ref. Ex. 1 | Yes | ZLI-4851-100 | 1 | 200 | 0.5 | 2 | No | ±10 V, 500 Hz, Triangular |
| Ref. Ex. 2 | Yes | ZLI-4851-100 | 1 | 5,000 | 0.1 | 2 | No | ±10 V, 500 Hz, Triangular |
| Ex. 2 | No | ZLI-4851-100 | 1 | 7,000 | 0.5 | 1 | ±2 V, 500 Hz; Triangular | ±10 V, 500 Hz, Triangular |
| Ref. Ex. 3 | Yes | ZLI-4851-100 | 1 | 5,000 | 0.5 | 5 | No | ±10 V, 500 Hz, Triangular |
| Ref. Ex. 4 | No | ZLI-4851-100 | 1 | 7,000 | 0.1 | 1 | ±2 V, 500 Hz; Triangular | ±10 V, 500 Hz, Triangular |
| Ref. Ex. 5 | No | ZLI-4851-100 | 1 | 200 | 0.1 | 1 | ±2 V, 500 Hz; Triangular | ±10 V, 500 Hz, Triangular |
| Ref. Ex. 6 | No | ZLI-1851-100 | 1 | 200 | 0.5 | 1 | ±2 V, 500 Hz; Triangular | ±10 V, 500 Hz, Triangular |
| Ref. Ex. 7 | Yes | ZLI-4851-100 | 6.5 | 5,000 | 0.5 | 2 | No | ±10 V, 500 Hz, Triangular |
| Ref. Ex. 8 | Yes | ZLI-4851-100 | 6.5 | 200 | 0.5 | 2 | No | ±10 V, 500 Hz, Triangular |
| Ref. Ex. 9 | Yes | ZLI-4851-100 | 6.5 | 5,000 | 0.1 | 2 | No | ±10 V, 500 Hz, Triangular |
| Ex. 3 | No | Naphthalene | 1 | 7,000 | 0.6 | 1 | ±1 V, 500 Hz; Triangular | ±7 V, 500 Hz, Triangular |
| Ref. Ex. 10 | No | Naphthalene | 1 | 600 | 0.2 | 1 | ±1 V, 500 Hz; Triangular | ±7 V, 500 Hz, Triangular |
| Ref. Ex. 11 | No | Naphthalene | 1 | 7,000 | 0.2 | 1 | ±1 V, 500 Hz; Triangular | ±7 V, 500 Hz, Triangular |
| Ref. Ex. 12 | No | Naphthalene | 1 | 7,000 | 0.6 | 3 | No | ±7 V, 500 Hz, Triangular |

### Example 1

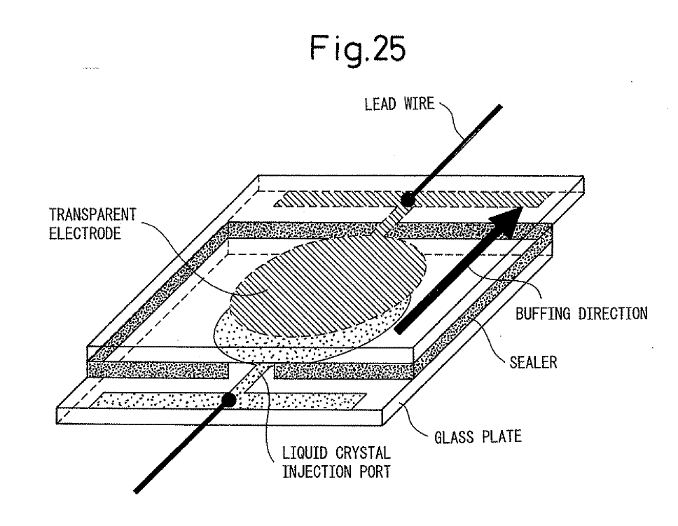

One example of the voltage control system is described as a working example of the present invention. Using a glass substrate having a size of 35 mm×35 mm and a thickness of 0.7 mm, a circular transparent electrode ITO of 15 mm in diameter was patterned on the glass substrate. As shown in the schematic perspective view of FIG. 25, the glass substrates were laminated together by arranging the transparent electrodes to face each other, whereby a PSS-LCD cell was prepared.

In order to make constant the size of a gap for the liquid crystal layer by laying two glass substrates to face each other, a silica spacer having a particle diameter of 1.8 μm was used. The surfaces of two glass substrates were coated with polyimide, then baked and further subjected to buffing such that the buffing directions became parallel when overlapping the substrates. Thereafter, the spacer above dispersed in ethanol was scattered on the glass substrate on one side at a ratio of 100 particles/mm² and after overlapping the two glass substrates by arranging the transparent electrodes to face each other, a two-component epoxy resin was filled and fixed in the overlapped portion to produce an empty cell.

Into this cell, a liquid crystal material for PSS-LCD (produced by Nano Loa Inc.) was injected at an isotropic phase temperature of 110° C. to produce a PSS-LCD cell. The angle of the optical axis azimuth of this panel was confirmed, as a result, the angle of the optical axis azimuth was almost parallel to the buffing direction.

A rectangular wave voltage of ±5 V with a frequency of 200 Hz was applied to the panel obtained above, and the angle at which the transmitted light quantity became minimum when applying a voltage of −5 V, that is, the optical axis azimuth was measured. At this time, the ambient temperature was varied from 30 to 60° C. to measure the temperature dependency of the optical axis azimuth rotation. In the measured ambient temperature of 30 to 60° C., the rotation angle of the optical axis azimuth at 60° C. was 21.5° and minimum. This angle becomes the reference angle for the compensation of temperature dependency.

This PSS-LCD cell was set in the cross-Nicol arrangement where as shown in FIG. 24, a polarizer is disposed perpendicularly to an analyzer. At this time, the cell was set such that the absorption axis of the analyzer became parallel to the reference angle of 21.5°.

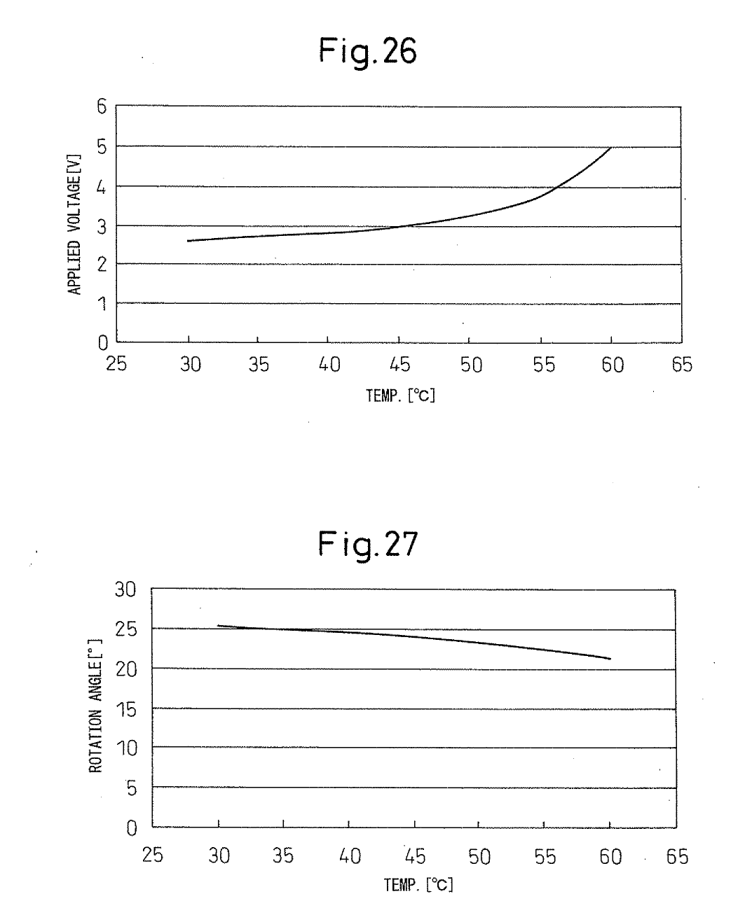

In such a construction, the voltage was controlled in accordance with the curve of FIG. 26 derived from the temperature dependency of the optical axis azimuth rotation measured above. In other words, this curve is a curve of the voltage at which the transmitted light quantity becomes minimum with respect to the ambient temperature. The results are shown in FIG. 18. It was confirmed that compared with the case of not controlling the voltage at all as in FIG. 9, variation of the contrast ratio is distinctly reduced.

### Example 2

One example of the control utilizing mechanical rotation in the present invention is described below.

Similarly to Example 1, using a glass substrate having a size of 35 mm×35 mm and a thickness of 0.7 mm, a circular transparent electrode ITO of 15 mm in diameter was patterned on the glass substrate. As shown in FIG. 25, the glass substrates were laminated together by arranging the transparent electrodes to face each other, whereby a PSS-LCD cell was prepared. In order to make constant the size of a gap for the liquid crystal layer by laying two glass substrates to face each other, a silica spacer having a particle diameter of 1.8 μm was used. The surfaces of two glass substrates were coated with polyimide, then baked and further subjected to buffing such that the buffing directions became parallel when overlapping the substrates. Thereafter, the spacer above dispersed in ethanol was scattered on the glass substrate on one side at a ratio of 100 particles/mm² and after overlapping the two glass substrates by arranging the transparent electrodes to face each other, a two-component epoxy resin was filled and fixed in the overlapped portion to produce an empty cell. Into this cell, a liquid crystal material for PSS-LCD (produced by Nano Loa Inc.) was injected at an isotropic phase temperature of 110° C. to produce a PSS-LCD cell. The angle of the optical axis azimuth of this panel was confirmed, as a result, the angle of the optical axis azimuth was almost parallel to the buffing direction.

A rectangular wave voltage of ±5 V with a frequency of 200 Hz was applied to the panel obtained above, and the angle at which the transmitted light quantity became minimum when applying a voltage of −5 V, that is, the optical axis azimuth was measured. At this time, the ambient temperature was varied from 30 to 60° C. to measure the temperature dependency of the optical axis azimuth rotation. The results are shown in FIG. 27.

This PSS-LCD cell was set in the cross-Nicol arrangement where as shown in. FIG. 24, a polarizer is disposed perpendicularly to an analyzer. Based on the optical axis azimuth when not applying a voltage to the PSS-LCD cell with respect to the absorption axis of the analyzer, the rotation angle was controlled by the ambient temperature in accordance with FIG. 27. The results are shown in FIG. 19. It was confirmed that similarly to Example 1, variation of the contrast ratio is distinctly reduced compared with the case of not controlling the rotation angle at all as in FIG. 9.

### INDUSTRIAL APPLICABILITY

According to the present invention described above, a liquid crystal element (for example, PSS-LCD) capable of rotating the optical axis azimuth in response to the strength and/or direction of an electric field to be applied thereto is used and the temperature compensation is performed utilizing electro-optical characteristic specific to such liquid crystal display, so that a liquid crystal device reduced in the temperature dependency while substantially maintaining high transmittance can be realized.

5. A liquid crystal device according to claim 1, wherein the liquid crystal element is capable of rotating the optical axis azimuth in response to the strength, and/or direction of an electric field to be applied thereto at a level of 10 to 2 V/μm.

6. A liquid crystal device according to claim 1, wherein the liquid crystal element is capable of high-speed response at a level of 1 ms or less.

7. A liquid crystal device according to claim 1, which has an optical shutter function.

8. A liquid crystal device according to claim 1, wherein the liquid crystal molecular alignment in the liquid crystal element can be represented by the temperature of the liquid crystal material.

9. A liquid crystal device according to claim 1, wherein the liquid crystal molecular alignment in the liquid crystal material can be represented by the intensity of output light from one of the polarizing elements.

10. A liquid crystal device according to claim 2, wherein the liquid crystal element is capable of rotating the optical axis azimuth in response to the strength and/or direction of an electric field to be applied thereto at a level of 10 to 2 V/μm.

11. A liquid crystal device according to claim 2, wherein the liquid crystal element is capable of high-speed response at a level of 1 ms or less.

12. A liquid crystal device according to claim 5, wherein the liquid crystal element is capable of high-speed response at a level of 1 ms or less.

13. A liquid crystal device according to claim 2, which has an optical shutter function.

14. A liquid crystal device according to claim 3, which has an optical shutter function.

15. A liquid crystal device according to claim 4, which has an optical shutter function.

16. A liquid crystal device according to claim 5, which has an optical shutter function.

17. A liquid crystal device according to claim 6, which has an optical shutter function.

18. A liquid crystal device according to claim 2, wherein the liquid crystal molecular alignment in the liquid crystal element can be represented by the temperature of the liquid crystal material.

19. A liquid crystal device according to claim 3, wherein the liquid crystal molecular alignment in the liquid crystal element can be represented by the temperature of the liquid crystal material.

20. A liquid crystal device according to claim 4, wherein the liquid crystal molecular alignment in the liquid crystal element can be represented by the temperature of the liquid crystal material.

21. A liquid crystal device according to claim 5, wherein the liquid crystal molecular alignment in the liquid crystal element can be represented by the temperature of the liquid crystal material.

22. A liquid crystal device according to claim 6, wherein the liquid crystal molecular alignment in the liquid crystal element can be represented by the temperature of the liquid crystal material.

23. A liquid crystal device according to claim 7, wherein the liquid crystal molecular alignment in the liquid crystal element can be represented by the temperature of the liquid crystal material.

24. A liquid crystal device according to claim 2, wherein the liquid crystal molecular alignment in the liquid crystal material can be represented by the intensity of output light from one of the polarizing elements.

25. A liquid crystal device according to claim 3, wherein the liquid crystal molecular alignment in the liquid crystal material can be represented by the intensity of output light from one of the polarizing elements.

26. A liquid crystal device according to claim 4, wherein the liquid crystal molecular alignment in the liquid crystal material can be represented by the intensity of output light from one of the polarizing elements.

27. A liquid crystal device according to claim 5, wherein the liquid crystal molecular alignment in the liquid crystal material can be represented by the intensity of output light from one of the polarizing elements.

28. A liquid crystal device according to claim 6, wherein the liquid crystal molecular alignment in the liquid crystal material can be represented by the intensity of output light from one of the polarizing elements.

29. A liquid crystal device according to claim 7, wherein the liquid crystal molecular alignment in the liquid crystal material can be represented by the intensity of output light from one of the polarizing elements.

30. A liquid crystal device according to claim 8, wherein the liquid crystal molecular alignment in the liquid crystal material can be represented by the intensity of output light from one of the polarizing elements.
